(19) United States
(12) Patent Application Publication
(10) Pub. No.: US 2021/0099576 A1
(43) Pub. Date: Apr. 1, 2021

(54) Global Dialing Format

(71) Applicant: Victor Tokunbo Ojesina, Houston, TX (US)

(72) Inventor: Victor Tokunbo Ojesina, Houston, TX (US)

(21) Appl. No.: 17/119,066

(22) Filed: Dec. 11, 2020

Related U.S. Application Data
(63) Continuation-in-part of application No. 16/504,402, filed on Jul. 8, 2019.
(60) Provisional application No. 62/695,203, filed on Jul. 9, 2018.

(51) Int. Cl. H04M 3/44; H04M 3/38

(52) U.S. Cl. CPC H04M 3/44; H04M 3/38

(57) ABSTRACT

Described herein is at least one non-transitory computer-readable medium comprising instructions to direct at least one processor to utilize a global dialing format. The at least one processor is directed to retrieve a phone number stored on a communication device. The retrieved phone number is converted to the global dialing format by a reformatting sequence or a manual intervention sequence and the reformatted phone number thereby obtained is saved to a global contacts list on the communication device. A local phone number is retrieved from the reformatted phone number when a user selects the reformatted phone number for dialing. The local phone number is in a destination country. A call logic sequence is initiated to assemble the dialing protocol necessary to complete the phone call. An authentication sequence is executed to confirm that the local phone number is an actual phone number in the destination country. The authentication sequence results in an authenticated local phone number which is concatenated with the dialing protocol assembled by the call logic sequence. A concatenated phone number is obtained. The retrieved phone number is saved to a call log in the global dialing format. The concatenated phone number is called.

### TECHNICAL FIELD

The present disclosure relates generally to a global dialing format for storing domestic and international phone numbers and placing phone calls to the stored numbers. More specifically, the present techniques relate to converting a phone number to the global dialing format and calling the reformatted phone number.

### BACKGROUND ART

There are multiple standards and conventions that govern the formatting of a phone number to be called. A user of a communication device must be familiar with these standards and conventions for countries throughout the world to successfully place domestic and international phone calls.

### BRIEF DESCRIPTION OF THE DRAWINGS

FIG. 1 is a logic flow diagram for converting a phone number to a global dialing format and calling the reformatted phone number.

FIG. 2 is a logic flow diagram for installing a software application that performs the functions disclosed herein.

FIGS. 3A and 3B are a logic flow diagram for determining how phone numbers are to be dialed.

FIGS. 4A and 4AA are a logic flow diagram for reformatting contact phone numbers.

FIGS. 4B and 4BB are a logic flow diagram of a first logic sequence of a reformatting sequence.

FIGS. 4C and 4CC are a logic flow diagram of a second logic sequence of the reformatting sequence.

FIGS. 4D and 4DD are a logic flow diagram of a third logic sequence of the reformatting sequence.

FIG. 4E is a logic flow diagram of a fourth logic sequence of the reformatting sequence.

FIG. 4F is a logic flow diagram of a manual intervention sequence.

FIG. 5A is an illustration of a screen that appears on a user's communication device during the manual intervention sequence.

FIG. 5B is an illustration of a screen that displays unresolved phone numbers.

FIG. 6 is an illustration of a home screen that appears after launch of the app.

FIG. 7A is an illustration of a screen that allows a user to sort a contacts list on the user's communication device.

FIG. 7B is an illustration of a screen that shows phone numbers saved to the user's call log in the TIN dialing format.

FIG. 8A is an illustration of a screen that shows global calling methods available on a communication device.

FIG. 8B is an illustration of a screen that asks for verification of dialing information when a local SIM card option is selected.

FIG. 9A is an illustration of a screen used to make a domestic phone call.

FIG. 9B is an illustration of a screen used to make phone calls from the call log on the user's communication device.

FIG. 9C is another illustration of a screen used to make a phone call.

FIG. 9D is an illustration of a screen used to make phone calls from the contacts list.

FIG. 9E is an illustration of a global dialer interface used to make an international phone call.

FIG. 10A is a logic flow diagram of a call logic sequence used to call a phone number.

FIGS. 10B and 10BB are a logic flow diagram of a domestic call logic sequence.

FIG. 10C is a logic flow diagram of a phone number verification logic sequence.

FIGS. 10D and 10DD are a logic flow diagram of an international call logic sequence.

FIG. 10E is a logic flow diagram of an alliance rule logic sequence.

FIGS. 11A and 11B are a process flow diagram of a method for using a global dialing format.

FIG. 12A is an illustration of a screen used to initiate an international phone call to Argentina.

FIG. 12B is an illustration of a screen used to make an international phone call to a land line in Argentina.

FIG. 12C is an illustration of a screen used to make an international phone call to a mobile device in Argentina.

FIG. 13 is an excerpt from a verification database.

FIGS. 14A and 14B are an excerpt from a dialing codes database.

FIG. 15 is an excerpt from a multiple carriers database.

The logic sequences shown in the logic flow diagrams may be implemented as instructions stored on at least one non-transitory, computer-readable medium. These instructions may be read and executed by at least one processor to perform the functions described herein. To facilitate the performance of these functions, the at least one processor may receive user input from the screens illustrated in the figures and may access the databases excerpted in the figures.

### DESCRIPTION OF THE EMBODIMENTS

A phone number must be dialed in a certain format if the phone call is to reach the intended recipient. However, this format is not necessarily the format in which the phone number is saved on a communication device.

A phone number must contain certain codes and prefixes depending upon the originating and destination countries. For example, a trunk prefix is required in most countries when placing domestic phone calls. An exit code for the originating country and an entry code for the destination country are required when placing international calls. If any necessary code or prefix is missing, a communication device cannot dial the phone number without manual intervention. A user has to add the missing code(s) or prefix(es) before the phone number can be dialed. This requires the user to be familiar with codes and prefixes for multiple countries.

When a global dialing format is used, a communication device saves a phone number in a format that is uniform across countries. A dialing logic sequence associated with the global dialing format captures codes and prefixes from various databases and concatenates the captured codes and prefixes with the phone number prior to dialing. The global dialing format and related dialing logic sequence obviate the need for the user to intervene and add any missing codes or prefixes when dialing a phone number.

The subject matter disclosed herein relates to the use of a global dialing format by a communication device. The present disclosure describes a software application that converts a phone number to the global dialing format and saves the reformatted phone number to a global contacts list on the communication device. To call the reformatted phone number, the software application retrieves a local phone number contained in the reformatted phone number, concatenates the local phone number and any necessary dialing codes or prefixes, and dials the concatenated phone number. For example, the software application may access a phone number saved on a communication device. A reformatting sequence may convert the phone number to the global dialing format. A manual intervention sequence may be invoked to convert the phone number when the reformatting sequence cannot accomplish the conversion. The reformatted phone number may be saved to the global contacts list on the communication device, whether the reformatted phone number is the result of the reformatting sequence or the manual intervention sequence. To call the phone number in the global dialing format, the local phone number may be retrieved from the reformatted phone number. The local phone number may be located in a destination country. A dialing logic sequence may be initiated. The dialing logic sequence may determine and assemble the dialing codes and prefixes necessary to dial the call. An authentication sequence may be executed to verify that the local phone number is located in the destination country. If authenticated, the local phone number may be concatenated with the dialing codes and prefixes captured during the execution of the dialing logic sequence. The concatenated phone number may be dialed. Various examples of the execution of the software application are described in detail below. Reference is made to the figures.

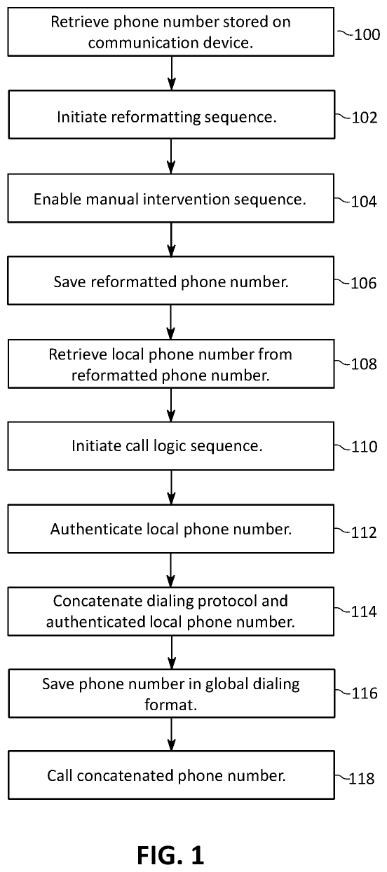

FIG. 1 is a logic flow diagram for converting a phone number to a global dialing format and calling the reformatted phone number. The logic begins at block 100, where a software application (app) may retrieve a phone number saved on a communication device. The term “communication device” may include mobile devices such as smart phones, laptops, tablets (e.g., iPods® and iPads®), and any other transportable electronic devices having sufficient computing capability to implement the embodiments described in the present disclosure. Further, the term “communication device” need not be limited to mobile devices. For example, a desktop computer may be used to implement the embodiments described herein.

At block 102, the reformatting sequence may be initiated. The reformatting sequence may convert the retrieved phone number to the global dialing format. The reformatted phone number may be a concatenation of a standardized country code and a local phone number in the destination country represented by the standardized country code. In an embodiment, the standardized country code may be a three-letter code. In particular, the three-letter code may be the International Organization for Standardization (ISO) country code for the destination country. The term “ISO country code” refers to a unique three-letter code for a country.

The global dialing format of the reformatted phone number may be the Toks ISO-Numeric (TIN) dialing format. The TIN dialing format is the concatenation of the ISO country code for the destination country and the local phone number. For example, a phone number in the United States would be “USA.2811234567” in the TIN format.

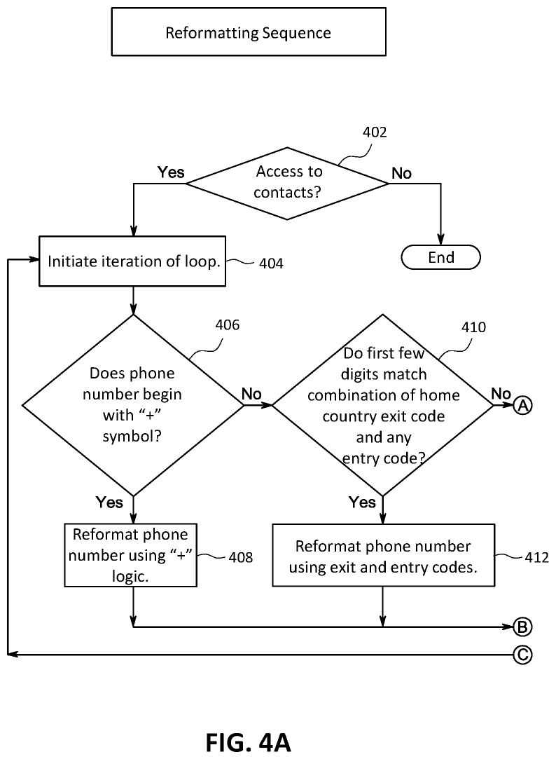

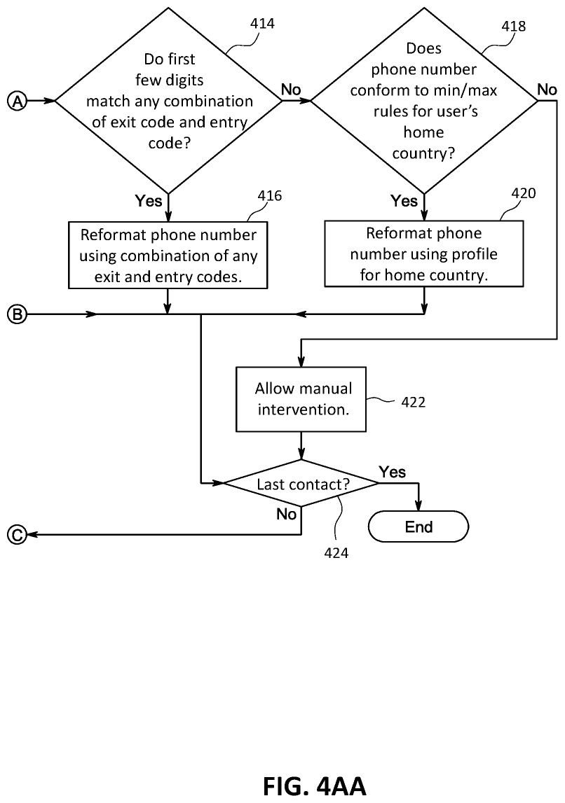

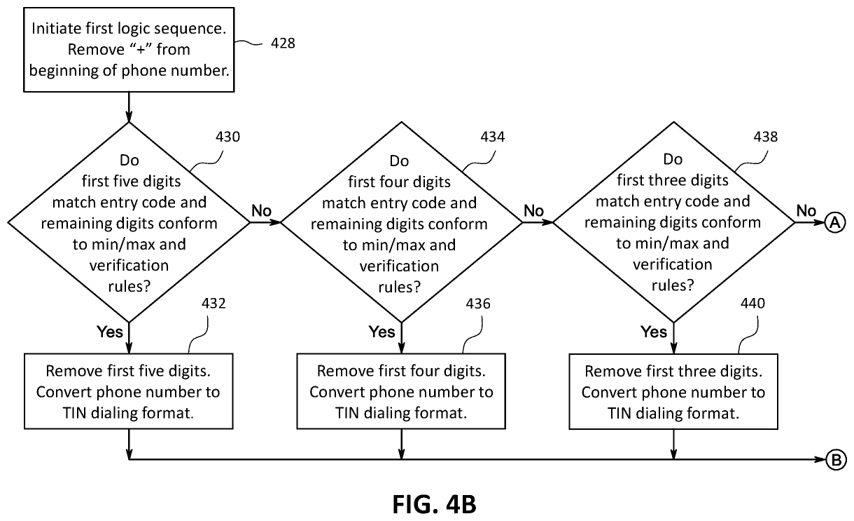

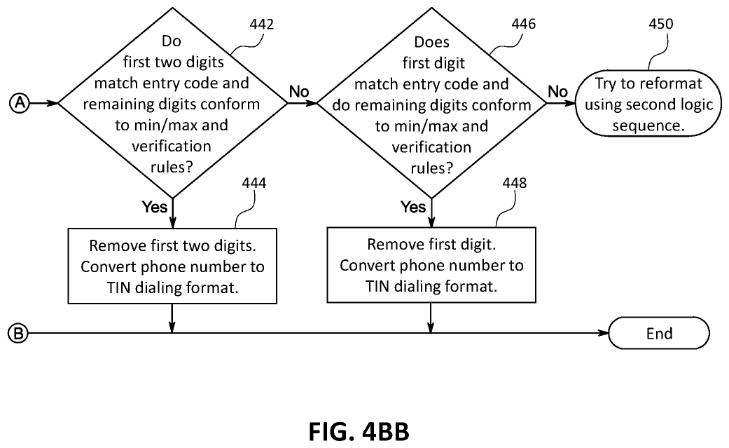

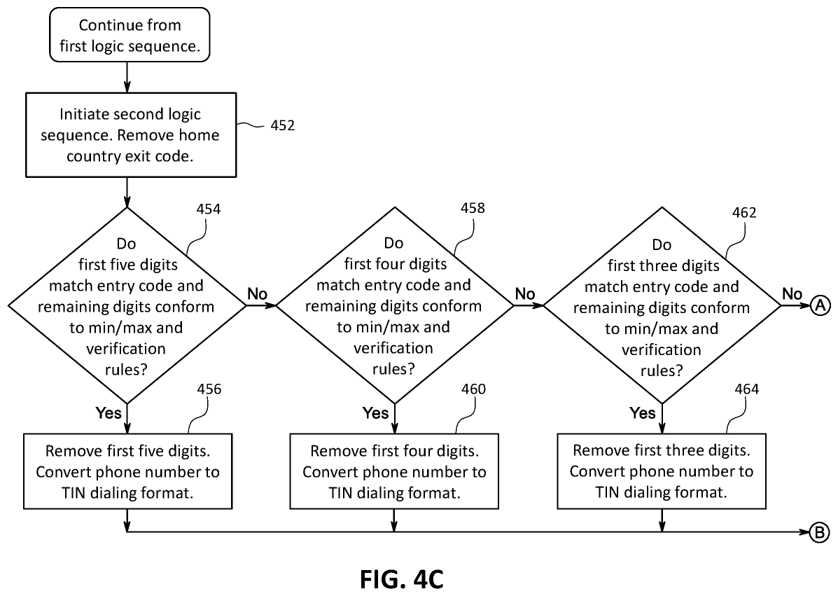

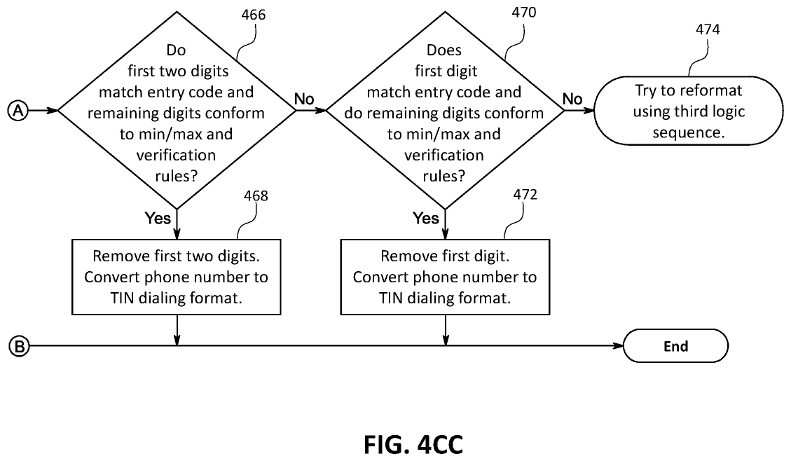

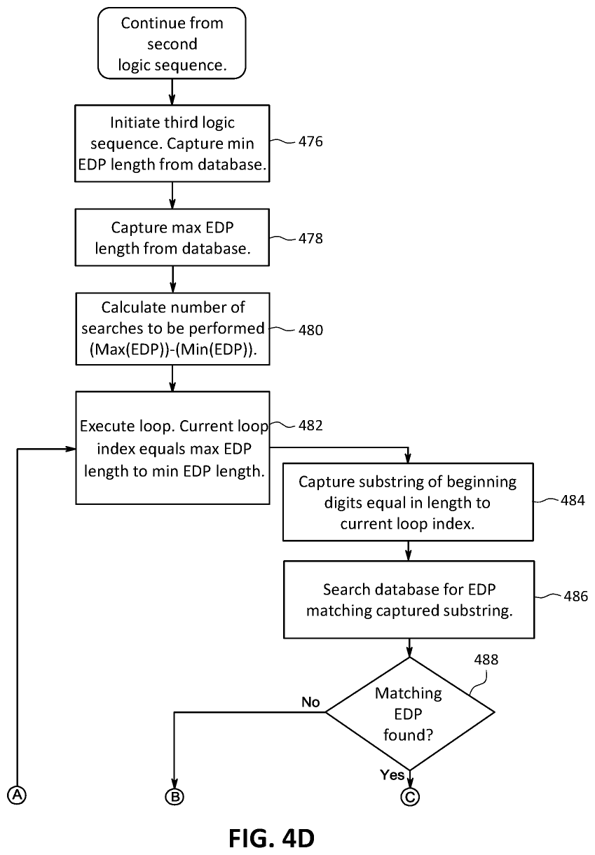

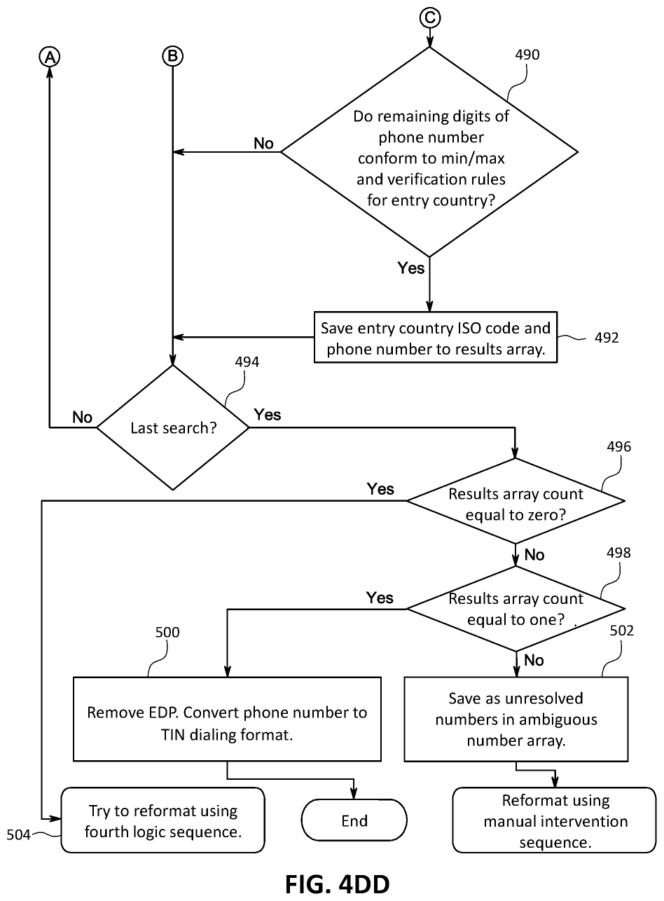

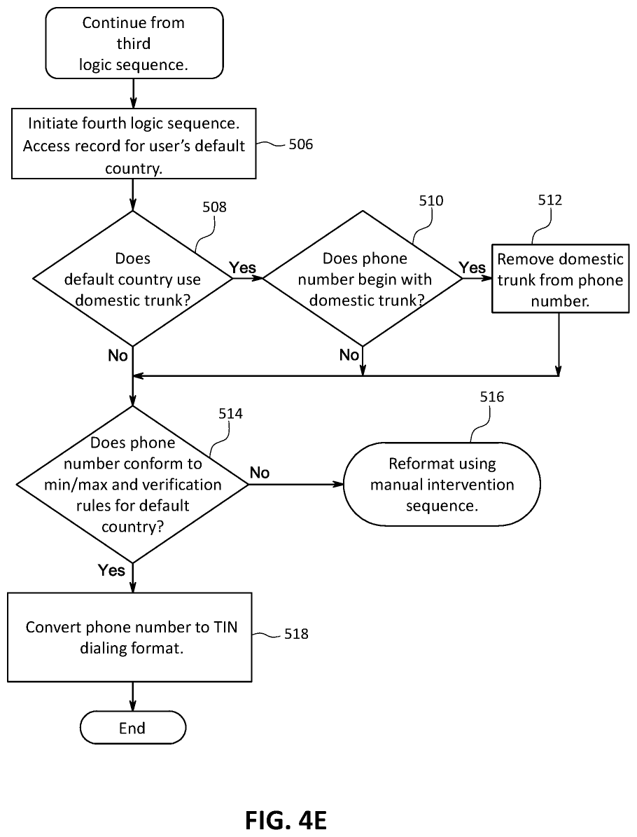

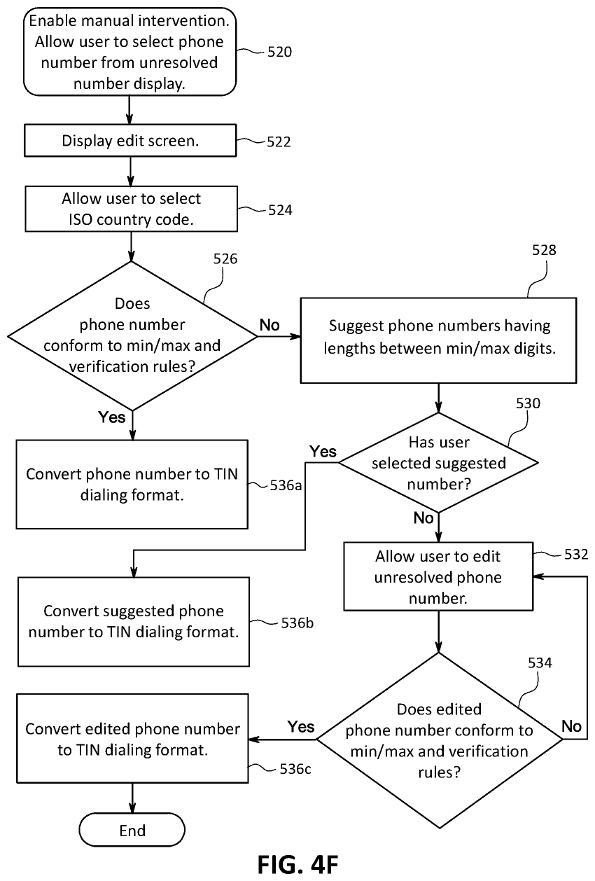

The reformatting sequence may by composed of four logic sequences. The first logic sequence, the second logic sequence, the third logic sequence, and the fourth logic sequence are depicted in FIGS. 4B and 4BB, 4C and 4CC, 4D and 4DD, and 4E, respectively. Each retrieved phone number may be reformatted by one of the four logic sequences. However, the reformatting sequence may be unable to convert a retrieved phone number to the global dialing format. When this occurs, a manual intervention sequence is enabled at block 104. The manual intervention sequence may allow a user to intercede and reformat the retrieved phone number. The user may reformat the phone number by interfacing with the app via interactive screens displayed on the communication device.

The reformatted phone number may be saved to a global contacts list on the communication device at block 106. The phone number is saved whether it was converted to the global dialing format by the reformatting sequence or the manual intervention sequence. The saved phone number may be dialed if selected by the user.

At block 108, the local phone number may be retrieved from the saved phone number. Block 108 may begin the conversion of the saved phone number to a dialable format. This conversion may be initiated when the user decides to dial the saved number and chooses it from a list of phone numbers stored on the communication device.

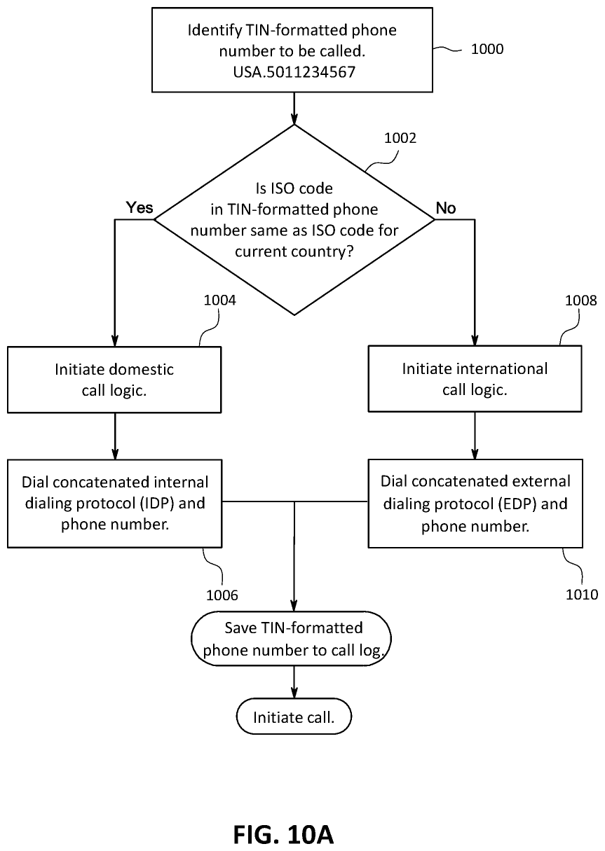

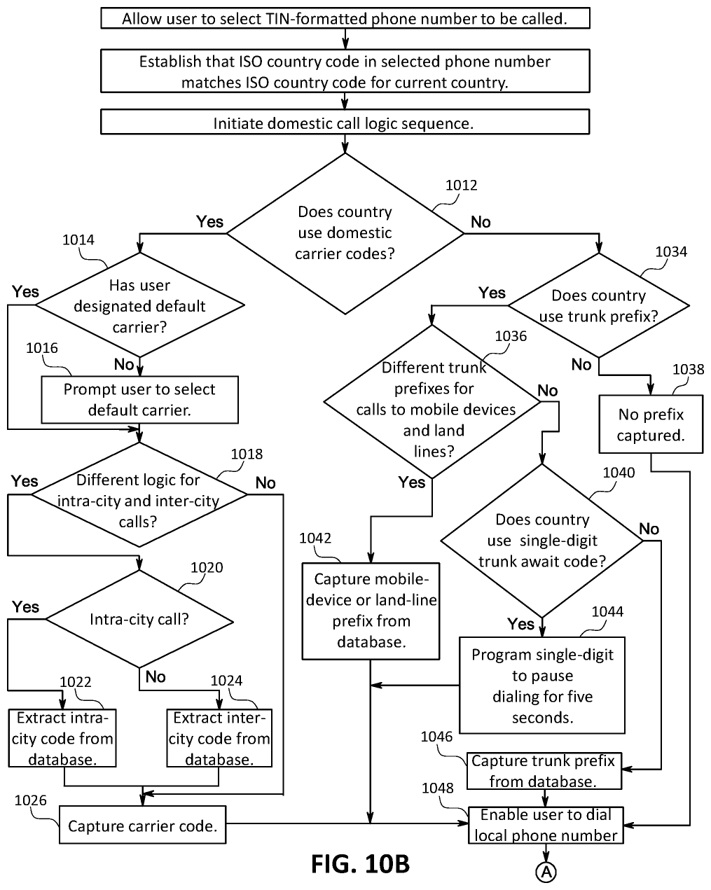

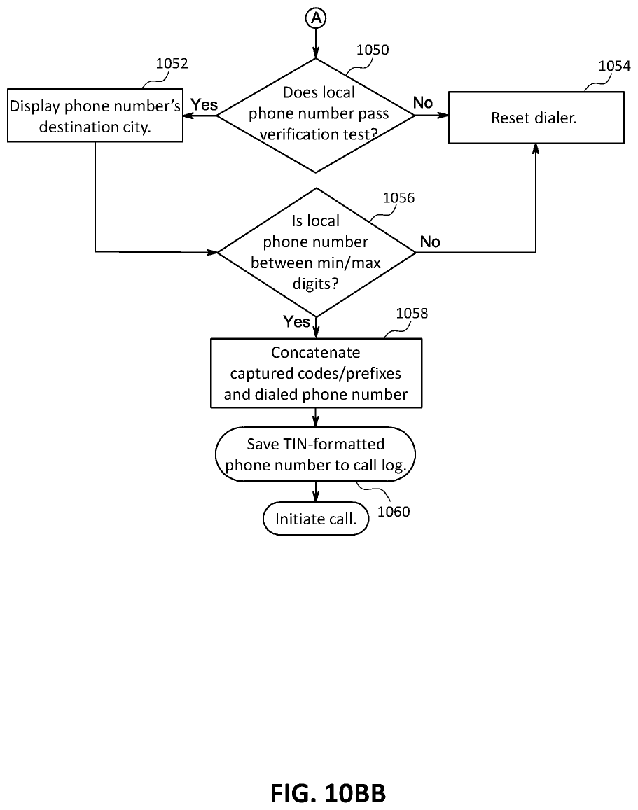

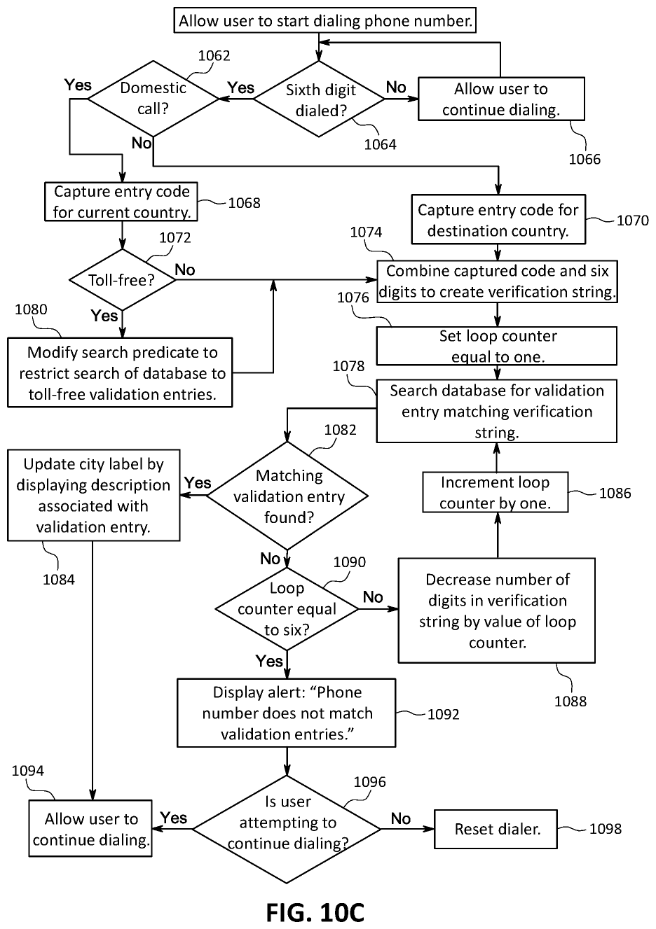

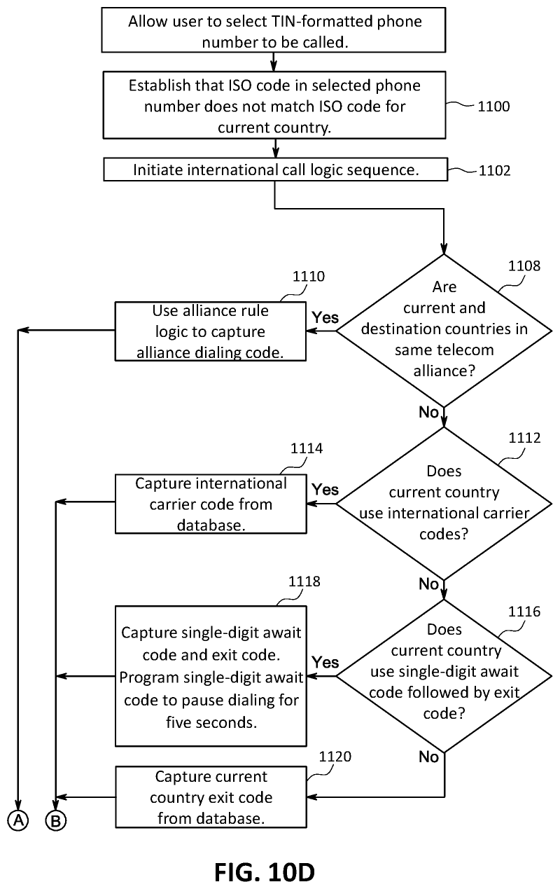

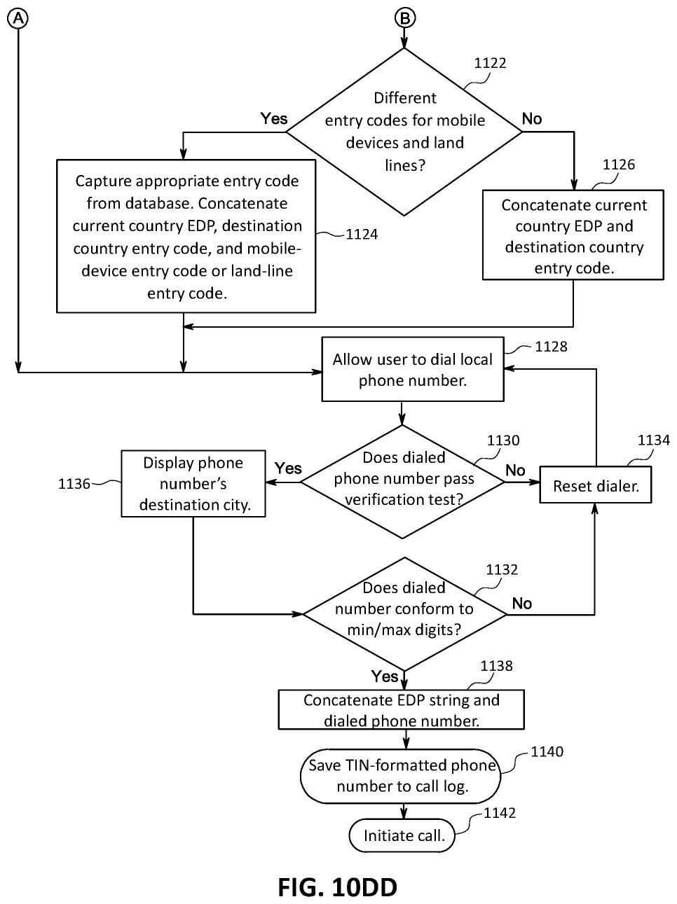

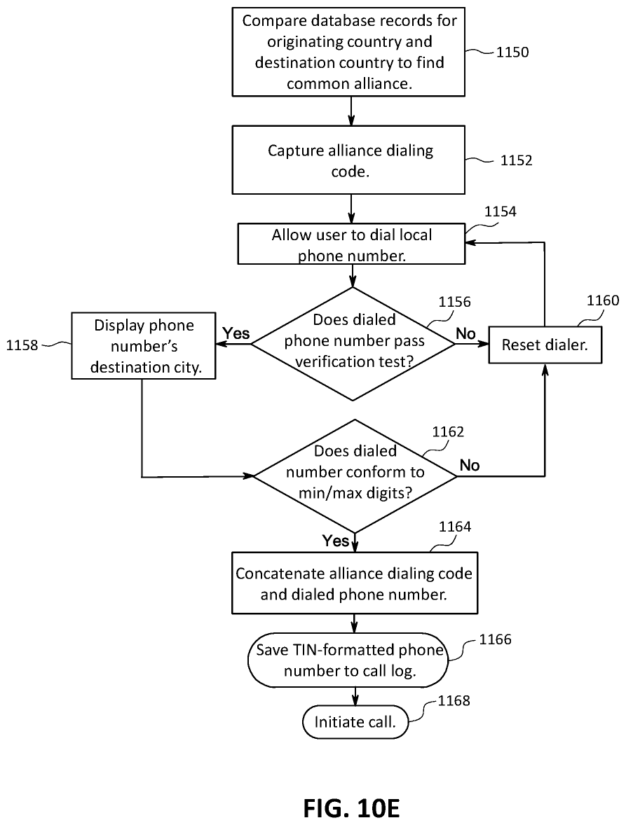

The call to the local phone number is made from an originating country to a destination country. The communication device may be in the originating country and may be able to determine its location. The destination country may be the country that corresponds to the ISO country code in the saved phone number. The originating country and the destination country may be compared to determine if they are the same. If the two countries are the same, a domestic call logic sequence may be invoked. If the two countries are different, an international call logic sequence may commence. The appropriate call logic sequence may be initiated at block 110. The call logic sequence may determine the dialing codes and prefixes necessary to complete the call to the local phone number. The domestic call logic sequence and the international call logic sequence are depicted in FIGS. 10B and 10BB and 10D and 10DD, respectively.

At block 112, the local phone number may be authenticated. The authentication process may confirm that the local phone number is an actual phone number in the destination country. Authentication may occur in two steps: a verification process and a digit count process. The verification process may compare the first few digits of the local phone number to sequences of digits that begin phone numbers in the destination country. The digit count process may determine if the local phone number has an appropriate number of digits for phone numbers in the destination country. An authenticated local phone number satisfies both the verification process and the digit count process.

At block 114, the authenticated local phone number may be concatenated with a dialing protocol. The dialing protocol may contain the dialing codes and prefixes needed to call the local phone number. The dialing codes and prefixes may have been identified and captured during the call logic sequence initiated at block 110. For example, the exit code for the originating country and the entry code for the destination country may constitute the dialing protocol that is combined with the local phone number. The concatenation of the dialing protocol and the local phone number may result in a concatenated phone number. At block 116, the retrieved phone number may be saved to the call log in the global dialing format. The concatenated phone number may be called at block 118.

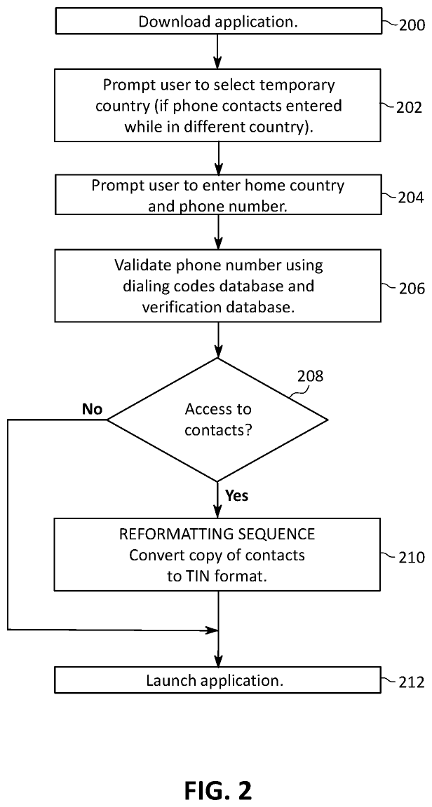

FIG. 2 is a logic flow diagram for installing a software application that performs the functions disclosed herein. In particular, the app may accomplish the tasks outlined in the discussion of FIG. 1. At block 200, the logic sequence may begin when the user downloads the app to a communication device.

At block 202, the user may be prompted to select a temporary country. The user may select the country in which he or she was residing when the current contacts were entered on his or her communication device. The temporary country and the user's current home country should be different. If a temporary country is selected, subsequent reformatting of the current contacts occurs as if the contacts were originally entered while the user was located in the temporary country.

At block 204, the user may be prompted to enter his or her home country and phone number. This information may be entered by the user via a screen displayed on the communication device. There may be alternative ways to determine the user's home country. For example, the user's home country may be retrieved from registration information stored on the communication device. Further, a global positioning system (GPS) receiver may ascertain the current country in which the communication device is located and the communication device may be configured to accept the current country as the user's default home country.

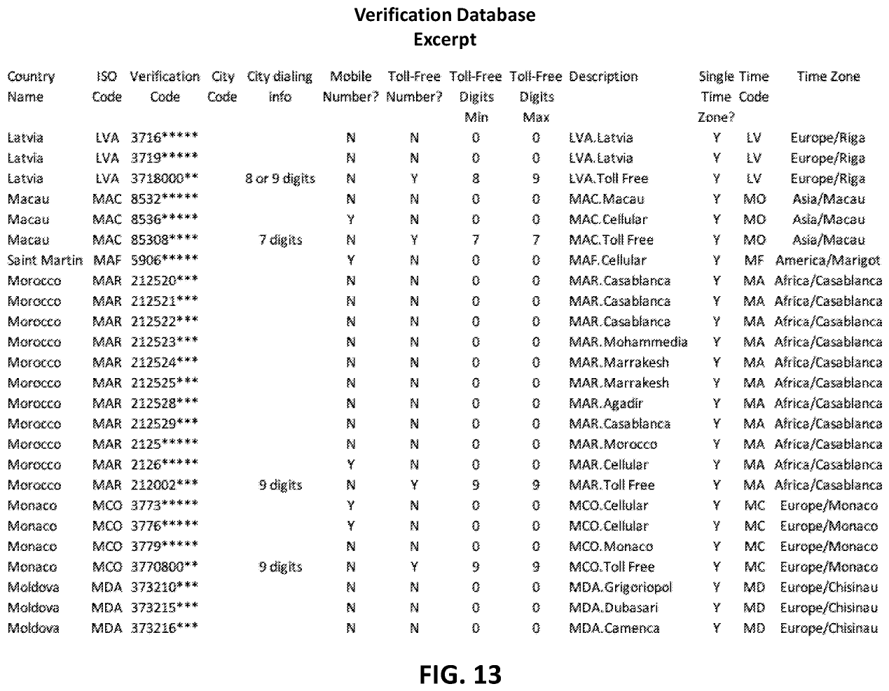

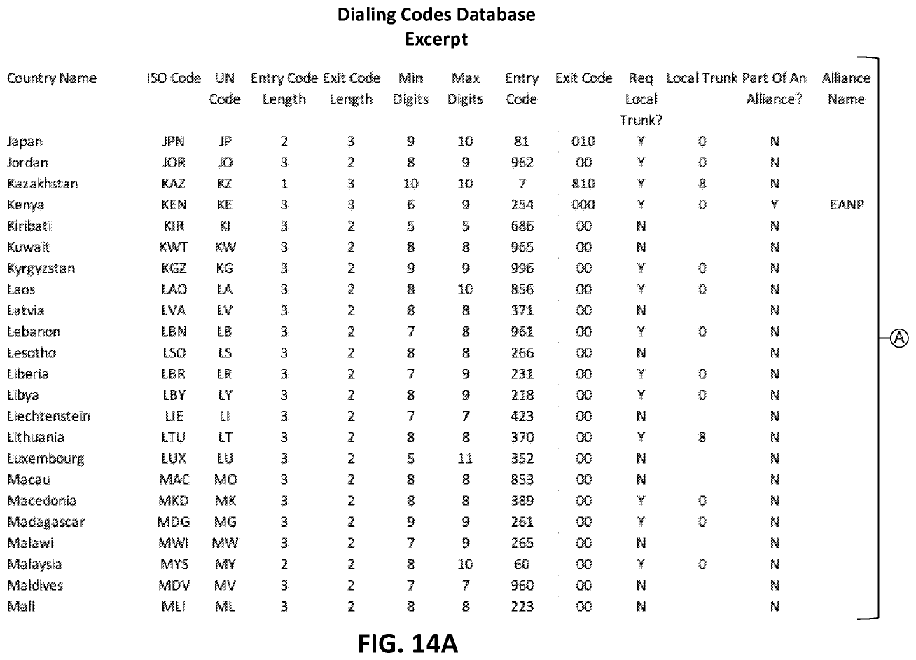

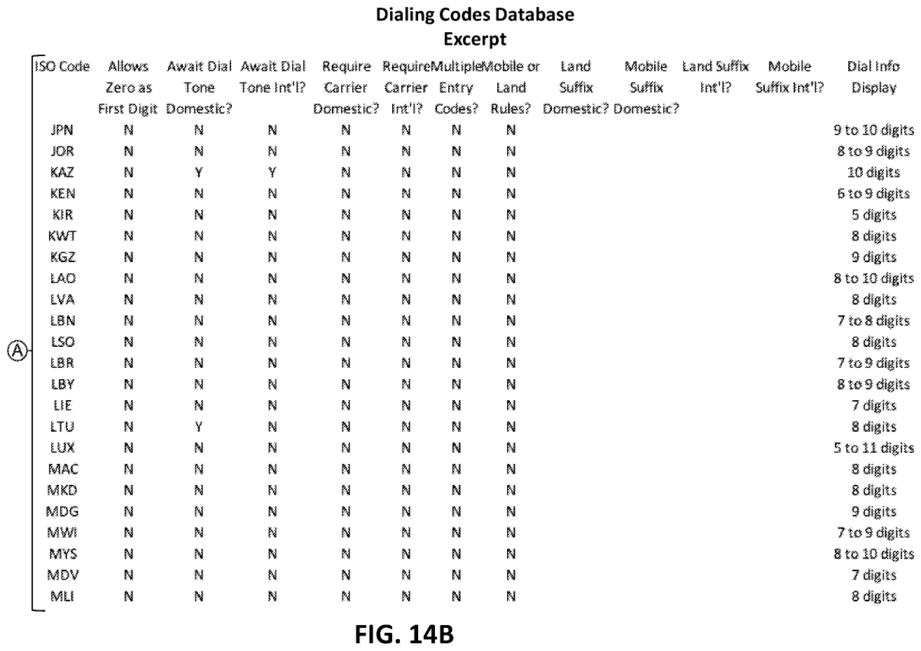

At block 206, the user's phone number may be validated. The validation process may determine if the user's phone number has the characteristics of phone numbers in the user's home country. The first part of the two-part validation process may begin when a minimum rule and a maximum rule are retrieved from a dialing codes database (excerpted in FIGS. 14A and 14B). The minimum and maximum rules (MMR) may specify the minimum and maximum number of digits contained in phone numbers in the user's home country. The number of digits in the user's phone number may be compared to the MMR. If the user's phone number has an acceptable number of digits, the verification sequences for the user's home country may be retrieved from a verification database (excerpted in FIG. 13). Verification sequences may be strings of digits found at the beginning of phone numbers in the user's home country. The initial digits of the user's phone number may be compared to the verification sequences. Validation may occur if a verification sequence matches the series of digits at the beginning of the user's phone number. If validated, the user's phone number has the features that typify phone numbers in the user's home country.

At block 208, the app may determine if the user has allowed access to his or her current contacts. If access is allowed, the logic sequence continues at block 210. The logic sequence continues at block 212 if access is withheld.

At block 210, the current contacts may be copied before the reformatting sequence is implemented. Each copy of a contact phone number may be converted to the TIN dialing format. A reformatted contact phone number may be the concatenation of the standardized country code for the destination country and the local phone number in the destination country.

At block 212, the user may launch the app on his or her communication device. Once launched, the app may convert a new contact to the TIN dialing format and add the reformatted contact to the contacts list. The same logic sequence may be used whether a contact phone number is reformatted before or after launch of the app. Reformatting of a phone number is described in detail with reference to FIGS. 4A through 4F.

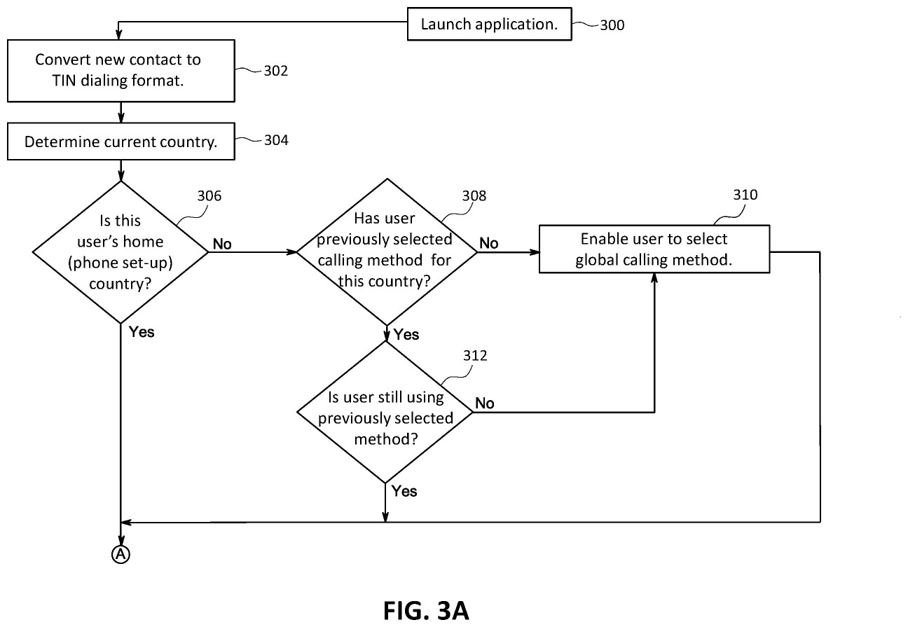

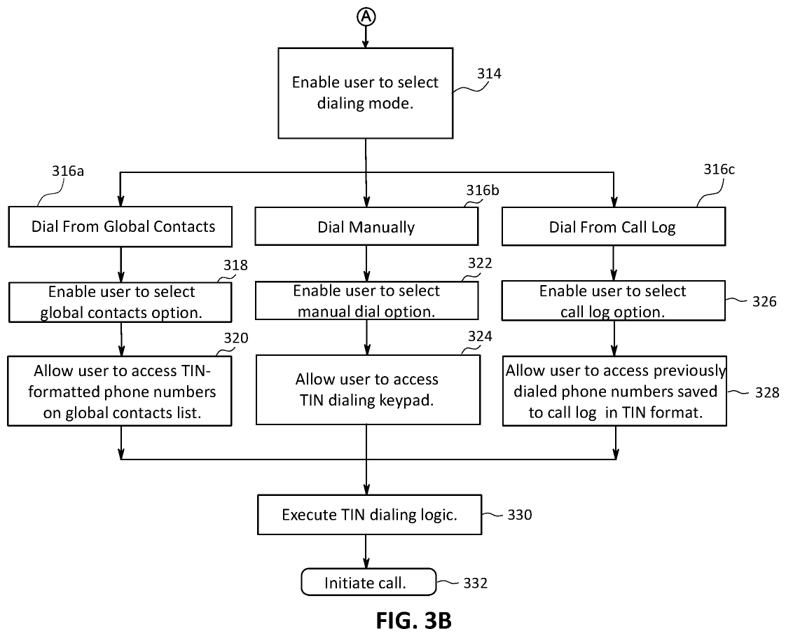

FIGS. 3A and 3B are a logic flow diagram for determining how phone numbers are to be dialed. The dialing of a phone number may be accomplished in one of three ways. The app may enable the user to select the manner in which a phone number is dialed. The selection made by the user may be influenced by several factors. FIGS. 3A and 3B depict these factors and how they combine to help the user choose the way a particular phone number will be dialed. The selection of a dialing mode may begin at block 302 after the app is launched on the user's communication device at block 300.

At block 302, the user may add a new contact to the contacts list on his or her communication device. The new contact may be converted to the TIN dialing format if the user allows the app to access the contacts list. The contact is referred to as “new” because it was added to the contacts list after the app was launched.

At block 304, the user's current country may be identified. The current country may be determined automatically or entered manually. The GPS receiver on the communication device may automatically identify the user's current country. Alternatively, the user may select his or her current country from a list of countries displayed on a screen of the communication device.

At block 306, the user's current country may be compared to the user's home country. The user's home country is the country in which the communication device was configured. If the user's current and home countries are the same, the logic sequence continues at block 314. If the two countries are different, the logic sequence continues at block 308.

At block 308, the user is in a country other than his or her home country and the app may determine if the user previously selected a calling method for the present country. The logic sequence continues at block 312 if a calling method has been selected. Otherwise, the logic sequence continues at block 310.

At block 312, the app may determine if the user is still using the previously selected calling method. If so, the logic sequence continues at block 314. If not, the logic sequence continues at block 310.

At block 310, the user may select a global calling method for use in the present country. The options available to the user may include a local SIM card, a global SIM card, a Wi-Fi network, an international calling plan, or the like. The logic sequence continues at block 314 once the user has chosen a global calling method.

At block 314, the app may enable the user to select a dialing mode. The user can choose to dial from the global contacts list at block 316a, dial manually at block 316b, or dial from the call log at block 316c. The user's choice determines the subsequent actions taken to prepare for execution of the TIN dialing logic at block 330.

The logic sequence continues at block 318 if the user decides to dial from the global contacts list at block 316a. At block 318, the app may enable the user to select the global contacts option by displaying a dialing options screen. The user selects the global contacts option and the logic sequence continues at block 320, where the app may allow the user to access the TIN-formatted phone numbers on the global contacts list. The phone numbers were previously converted to the TIN dialing format by a reformatting sequence.

The logic sequence continues at block 322 if the user decides to manually dial the phone number at block 316b. At block 322, the app may enable the user to select the manual dial option from the dialing options screen. The user selects the manual dial option and the logic sequence continues at block 324, where the app allows the user to access a TIN dialing keypad on a global dialer screen.

The logic sequence continues at block 326 if the user decides to dial from the call log at block 316c. At block 326, the app may enable the user to select the call log option from the dialing options screen. The user selects the call log option and the logic sequence continues at block 328. At block 328, the app may allow the user to access previously dialed phone numbers saved to the call log in the TIN dialing format.

Block 330 is reached no matter which dialing option is selected by the user. The logic sequence may advance from block 320, 324, or 328 to block 330, where the TIN dialing logic is executed. During implementation of the dialing logic, the app may enable the user to dial a local phone number in a destination country. The local phone number is dialed when the user selects the TIN-formatted phone number from the global contacts list accessed at block 320 or the call log accessed at block 328. Alternatively, the user may dial the local phone number when he or she enters the digits of the local phone number using the TIN dialing keypad accessed at block 324.

The TIN dialing logic may determine the dialing codes or prefixes that have to be combined with the local phone number to complete the call. The dialing codes or prefixes are concatenated with the local phone number and the call to the concatenated phone number is initiated at block 332. TIN dialing logic is explained in detail with reference to FIGS. 10A through 10E.

For purposes of this disclosure, dialing and calling of a phone number are considered two different actions. This is evident in FIG. 3B, where dialing of the phone number takes place at block 330 and calling of the phone number is initiated at block 332. Dialing occurs when the digits of the local phone number are input to the user's communication device. In the context of FIG. 3B, dialing constitutes selecting or entering the local phone number to be called. The TIN dialing logic adds the appropriate dialing codes or prefixes and the concatenated phone number is called when the phone number is passed to a telecommunications network by the communication device. The network routes the phone call to the intended recipient. The distinction between dialing and calling is apparent in other figures that accompany the present disclosure.

FIGS. 4A and 4AA are a logic flow diagram for reformatting contact phone numbers. In particular, the reformatting sequence may convert a contact phone number to the TIN dialing format. The reformatted phone number may be a concatenation of an ISO country code and a local phone number in a destination country represented by the ISO country code. The logic sequence begins at block 402.

At block 402, the app may determine if it has been allowed access to the contacts list on the user's communication device. The user may allow access if his or her contact phone numbers have not been reformatted. If access is allowed, the reformatting sequence may begin at block 404. If access is denied, the reformatting sequence is not executed.

At block 404, the reformatting sequence may begin by initiating a loop. The loop may iterate until all the phone numbers in the contacts list have been reformatted. The loop may commence at block 406.

At block 406, the app may determine if the phone number begins with a symbol. The “+” symbol is the exit code for most countries. An exit code should precede a phone number when placing an international call. Exit codes are also known as international call prefixes and dial-out codes.

If the phone number starts with the “+” symbol, the reformatting sequence may progress from block 406 to block 408. At block 408, “+” logic may be utilized to convert the phone number to the global dialing format. The use of “+” logic is explained in detail with reference to FIGS. 4B and 4BB. The reformatting sequence may continue at block 424 after “+” logic has converted the contact phone number to the global dialing format.

The reformatting sequence may progress from block 406 to block 410 if the phone number does not begin with the “+” symbol. At block 410, the app may determine if the first few digits of the phone number match a combination of the exit code for the user's home country and an entry code for any country. The entry code may contain five digits at most and designates which country is to be called. The entry code is dialed after the exit code and before the phone number. The terms “entry code” and “dial-in code” may be used interchangeably.

The reformatting sequence may continue at block 412 if the first few digits of the phone number match a combination of the home country's exit code and any country's entry code. At block 412, the phone number may be reformatted using the combination of the exit and entry codes. Block 412 is explained in detail with reference to FIGS. 4C and 4CC. The reformatting sequence may continue at block 424 once the phone number has been converted to the global dialing format.

The reformatting sequence may advance from block 410 to block 414 if the first few digits of the phone number do not match a combination of the home country's exit code and any country's entry code. At block 414, the app may determine if the first few digits of the phone number match any combination of an exit code and an entry code. If a matching combination is found, the reformatting sequence may continue at block 416. At block 416, the phone number may be reformatted using the combination of any exit code and any entry code. Block 416 is explained in detail with reference to FIGS. 4D and 4DD. The reformatting sequence may progress from block 416 to block 424 once the phone number has been converted to the global dialing format.

The reformatting sequence may continue at block 418 if a matching combination of any exit code and any entry code is not found at block 414. At block 418, the app may determine if the phone number contains at least a minimum number of digits and at most a maximum number of digits specified in a minimum rule and a maximum rule for the user's home country. If the phone number satisfies the minimum and maximum rules, the phone number may be a domestic phone number. In other words, the phone number's originating country and destination country are both the user's home country. A domestic phone number may be reformatted at block 420. At block 420, a country profile for the user's home country may be used to reformat the phone number. A country profile may include a set of rules that govern the reformatting of domestic phone numbers. Country profiles may vary because different countries have different reformatting rules. Block 420 is explained in detail with reference to FIG. 4E.

The reformatting sequence may progress from block 418 to block 422 if the phone number does not satisfy the minimum and maximum rules for the user's home country. At block 422, manual intervention may be initiated. Manual intervention is necessary because some phone numbers cannot be converted to the global dialing format at blocks 408, 412, 416, or 420. These phone numbers are termed “ambiguous phone numbers.”

One type of ambiguous phone number conforms to the minimum and maximum rules (MMR) and the verification sequences for two or more countries. The phone number “0096536745987” is an example of this type of ambiguous phone number. The first five digits “00965” could be a combination of the exit code “00” for Great Britain and the entry code “965” for Kuwait. The remainder “36745987” conforms to the MMR and a verification sequence for Kuwait. However, the first five digits “00965” could also be a combination of the exit code “009” for Nigeria and the entry code “65” for Singapore. The remainder “36745987” conforms to the MMR and a verification sequence for Singapore. Thus, “0096536745987” could be a phone number in Kuwait or Singapore.

Another type of ambiguous phone number is added to a contacts list while the user is located outside his or her home country. For instance, during a visit to another country, the phone number “0562425648” may be saved to the contacts list on the user's communication device. This phone number begins with the trunk prefix “0” which is the domestic prefix for 95 countries. Of these 95 countries, 64 countries have minimum and maximum rules that are satisfied by the remaining nine digits “562425648.” The phone number could be from any of these 64 countries. The reformatting sequence cannot convert “0562425648” to the global dialing format because this phone number could be located in any of a multitude of countries.

During manual intervention, the user may interact with the app to reformat an ambiguous phone number. The user and the app may work together in several different ways. For example, the user may select an ISO country code from a list displayed on his or her communication device. The app may determine if the phone number conforms to the minimum, maximum, and verification rules for the country corresponding to the ISO country code selected by the user. If there is conformity, the app may reformat the phone number. If there is no conformity, there may be an alternative type of interaction that accomplishes the conversion of the phone number to the global dialing format. Manual intervention is explained in detail with reference to FIG. 4F.

The logic sequence may continue at block 424 once manual intervention results in the reformatting of an ambiguous phone number. The reformatting sequence always advances to block 424 after a phone number has been converted to the global dialing format. Reformatting may occur at blocks 408, 412, 416, 420, and 422 and the reformatting sequence may progress from each of these blocks to block 424. At block 424, the app may determine if the last of the contacts has been reformatted. The logic sequence may end if the last phone number on the contacts list has been converted to the global dialing format. If the last contact has not been reformatted, the reformatting sequence continues at block 404 and another iteration of the loop begins. The loop repeats itself until all the contacts have been converted to the global dialing format.

FIGS. 4B and 4BB are a logic flow diagram of a first logic sequence of a reformatting sequence. The first logic sequence may be used to reformat phone numbers starting with a “+” symbol. The first logic sequence is the same as the “+” logic discussed with reference to FIGS. 4A and 4AA.

The first logic sequence starts at block 428, where the “+” symbol may be removed from the beginning of a phone number. At block 430, the app may determine if the first five digits of the phone number match a country's entry code and the remaining digits conform to the country's minimum, maximum, and verification rules. In an embodiment, the dialing codes database (excerpted in FIGS. 14A and 14B) may be searched for an entry code that matches the first five digits of the phone number. If a match is found, the country associated with the entry code may be identified. The minimum and maximum rules for the country may be found in the dialing codes database and the verification rules may be found in the verification database (excerpted in FIG. 13).

The first logic sequence may continue at block 432 if the criteria at block 430 are satisfied. At block 432, the first five digits may be removed from the phone number and the phone number may be converted to the TIN dialing format “ISO.number.” “ISO” corresponds to the ISO country code for the country having the matching entry code and “number” corresponds to the digits remaining after the first five digits have been removed. Hence, the TIN dialing format is a concatenation of the ISO country code for the destination country (i.e., the country to be called) and the local phone number in the destination country.

The first logic sequence may continue at block 434 if the criteria at block 430 are not satisfied. At block 434, the app may determine if the first four digits of the phone number match a country's entry code and the remaining digits conform to the country's minimum, maximum, and verification rules. The first logic sequence may continue at block 436 if the criteria at block 434 are satisfied. At block 436, the first four digits may be removed from the phone number and the phone number may be converted to the TIN dialing format.

The first logic sequence may continue at block 438 if the criteria at block 434 are not satisfied. At block 438, the app may determine if the first three digits of the phone number match a country's entry code and the remaining digits conform to the country's minimum, maximum, and verification rules. The first logic sequence may continue at block 440 if the criteria at block 438 are satisfied. At block 440, the first three digits may be removed from the phone number and the phone number may be converted to the TIN dialing format.

The first logic sequence may continue at block 442 if the criteria at block 438 are not satisfied. At block 442, the app may determine if the first two digits of the phone number match a country's entry code and the remaining digits conform to the country's minimum, maximum, and verification rules. The first logic sequence may continue at block 444 if the criteria at block 442 are satisfied. At block 444, the first two digits may be removed from the phone number and the phone number may be converted to the TIN dialing format.

The first logic sequence may continue at block 446 if the criteria at block 442 are not satisfied. At block 446, the app may determine if the first digit of the phone number matches a country's entry code and the remaining digits conform to the country's minimum, maximum, and verification rules. The first logic sequence may continue at block 448 if the criteria at block 446 are satisfied. At block 448, the first digit is removed from the phone number and the phone number is converted to the TIN dialing format.

The first logic sequence may continue at block 450 if the criteria at block 446 are not satisfied. If block 450 is reached, the app may have failed to reformat the phone number using the first logic sequence. At block 450, the first logic sequence may transition to the second logic sequence.

FIGS. 4B and 4BB show one configuration of the first logic sequence. Blocks 430, 434, 438, 442, and 446 are queries that determine how the first logic sequence progresses. These blocks are arranged linearly in FIGS. 4B and 4BB. Alternatively, the first logic sequence may be configured as a loop. Prior to execution of the loop, the “+” symbol may be removed from the beginning of the phone number and a current loop counter may be set to five.

The loop may commence when the phone number is divided into a beginning series having a number of digits equal to the current loop counter and a remaining series of digits equal to the phone number minus the beginning series of digits. The app may determine if the beginning series of digits matches a country's entry code and the remaining series of digits conforms to the country's minimum, maximum, and verification rules. If these criteria are satisfied, the beginning series of digits may be removed from the phone number and the phone number may be converted to the TIN dialing format “ISO.number.” “ISO” corresponds to the ISO country code for the country having the matching entry code and “number” corresponds to the digits remaining after the beginning series of digits has been removed. Hence, the TIN dialing format is a concatenation of the ISO country code for the destination country (i.e., the country to be called) and the local phone number in the destination country.

If the criteria are not satisfied, the current loop counter may be decremented by one and the loop may be repeated. For example, the current loop counter would be equal to four when the loop iterates for the second time and the beginning series of digits would be four digits in length. The loop may repeat itself until the phone number is reformatted or five iterations have been completed. After five iterations, the first logic sequence may have failed to reformat the phone number and the app may proceed to execute the second logic sequence.

FIGS. 4C and 4CC are a logic flow diagram of a second logic sequence of the reformatting sequence. The second logic sequence may be used to reformat phone numbers starting with the exit code for the user's current country.

The second logic sequence starts at block 452, where the exit code for the user's current country may be removed from the beginning of the phone number. A remainder of the phone number may result. The remainder is the series of digits remaining after the current country exit code has been removed. At block 454, the app may determine if the first five digits of the remainder of the phone number match a country's entry code and the remaining digits conform to the country's minimum, maximum, and verification rules. In an embodiment, the dialing codes database (excerpted in FIGS. 14A and 14B) may be searched for an entry code that matches the first five digits of the remainder of the phone number. If a match is found, the country associated with the entry code may be identified. The minimum and maximum rules for the country may be found in the dialing codes database and the verification rules may be found in the verification database (excerpted in FIG. 13).

The second logic sequence may continue at block 456 if the criteria at block 454 are satisfied. At block 456, the first five digits may be removed from the remainder of the phone number and the phone number may be converted to the TIN dialing format “ISO.number.” “ISO” corresponds to the ISO country code for the country having the entry code that matches the first five digits and “number” corresponds to the digits remaining after the first five digits have been removed. Hence, the TIN dialing format is a concatenation of the ISO country code for the destination country (i.e., the country to be called) and the local phone number in the destination country.

The second logic sequence may continue at block 458 if the criteria at block 454 are not satisfied. At block 458, the app may determine if the first four digits of the remainder of the phone number match a country's entry code and the remaining digits conform to the country's minimum, maximum, and verification rules. The second logic sequence may continue at block 460 if the criteria at block 458 are satisfied. At block 460, the first four digits may be removed from the remainder of the phone number and the phone number may be converted to the TIN dialing format.

The second logic sequence may continue at block 462 if the criteria at block 458 are not satisfied. At block 462, the app may determine if the first three digits of the remainder of the phone number match a country's entry code and the remaining digits conform to the country's minimum, maximum, and verification rules. The second logic sequence may continue at block 464 if the criteria at block 462 are satisfied. At block 464, the first three digits may be removed from the remainder of the phone number and the phone number may be converted to the TIN dialing format.

The second logic sequence may continue at block 466 if the criteria at block 462 are not satisfied. At block 466, the app may determine if the first two digits of the remainder of the phone number match a country's entry code and the remaining digits conform to the country's minimum, maximum, and verification rules. The second logic sequence may continue at block 468 if the criteria at block 466 are satisfied. At block 468, the first two digits may be removed from the remainder of the phone number and the phone number is converted to the TIN dialing format.

The second logic sequence may continue at block 470 if the criteria at block 466 are not satisfied. At block 470, the app may determine if the first digit of the remainder of the phone number matches a country's entry code and the remaining digits conform to the country's minimum, maximum, and verification rules. The second logic sequence may continue at block 472 if the criteria at block 470 are satisfied. At block 472, the first digit is removed from the remainder of the phone number and the phone number is converted to the TIN dialing format.

The second logic sequence may continue at block 474 if the criteria at block 470 are not satisfied. If block 474 is reached, the app may have failed to reformat the phone number using the second logic sequence. At block 474, the second logic sequence may transition to the third logic sequence.

FIGS. 4C and 4CC show one configuration of the second logic sequence. Blocks 454, 458, 462, 466, and 470 are queries that determine how the second logic sequence progresses. These blocks are arranged linearly in FIGS. 4C and 4CC. Alternatively, the second logic sequence may be configured as a loop. Prior to execution of the loop, the exit code for the user's current country may be removed from the beginning of the phone number. A remainder of the phone number may result. The remainder is the series of digits remaining after the exit code has been removed. In addition, a current loop counter may be set to five.

The loop may commence when the remainder of the phone number is divided into a beginning series having a number of digits equal to the current loop counter and a remaining series of digits equal to the remainder of the phone number minus the beginning series of digits. The app may determine if the beginning series of digits matches a country's entry code and the remaining series of digits conforms to the country's minimum, maximum, and verification rules. If these criteria are satisfied, the beginning series of digits may be removed from the remainder of the phone number and the phone number may be converted to the TIN dialing format “ISO.number.” “ISO” corresponds to the ISO country code for the country having the entry code that matches the beginning series of digits and “number” corresponds to the remaining series of digits. Hence, the TIN dialing format is a concatenation of the ISO country code for the destination country (i.e., the country to be called) and the local phone number in the destination country.

If the criteria are not satisfied, the current loop counter may be decremented by one and the loop may be repeated. For example, the current loop counter would be equal to four when the loop iterates for the second time and the beginning series of digits would be four digits in length. The loop may repeat itself until the phone number is reformatted or five iterations have been completed. After five iterations, the second logic sequence may have failed to reformat the phone number and the app may proceed to execute the third logic sequence.

FIGS. 4D and 4DD are a logic flow diagram of a third logic sequence of the reformatting sequence. The third logic sequence may identify an external dialing protocol (EDP) at the beginning of a phone number. An EDP is a combination of an exit code and an entry code. For example, an international phone call from the United States to Poland would have an EDP of “01148.” This EDP is a combination of the exit code “011” for the United States and the entry code “48” for Poland.

The third logic sequence may begin at block 476, where a minimum EDP length may be captured from a database stored on the user's communication device. The database may contain all possible EDPs. The EDPs may be surveyed and the EDP(s) having the fewest number of digits may be identified. For example, the minimum EDP length may be equal to three. At block 478, the maximum EDP length may be captured from the database. For example, the maximum EDP length may be equal to eight.

At block 480, the app may determine how many times the database has to be searched to identify the EDP at the beginning of a phone number. The number of searches to be performed may be calculated by subtracting the minimum EDP length from the maximum EDP length. For example, the number of searches to be performed may be calculated by subtracting the minimum EDP length of three from the maximum EDP length of eight to obtain five.

A loop may be initiated at block 482. A search of the database may occur each time the loop iterates. Hence, the number of iterations of the loop may equal the number of searches calculated at block 480. For example, the loop may iterate five times. A current loop index for the first iteration may be equal to the maximum EDP length captured from the database. For example, the current loop index for the first iteration of the loop may be equal to eight. As the loop iterates, the current loop index may decrement until the number of completed iterations equals the calculated number of searches. For example, the second iteration of the loop may have a current loop index equal to seven and the current loop index may continue to decrement until five iterations have been completed. The last iteration may have a current loop index equal to three, the minimum EDP length captured from the database.

At block 484, the app may capture a substring of the digits at the beginning of the phone number. The number of digits in the captured substring may equal the current loop index. The capture of the substring may create a remainder of the phone number. The remainder is equal to the phone number minus the captured substring.

At block 486, the database stored on the user's communication device may be searched for an EDP that matches the captured substring. At block 488, the app may determine if a matching EDP has been located. If a match is found, the app may identify the country associated with the entry code in the EDP. This country is designated the destination country. The third logic sequence may advance to block 490 once the destination country has been identified. If a match is not found at block 488, the third logic sequence may continue at block 494.

At block 490, the app may determine if the remainder of the phone number conforms to the minimum, maximum, and verification rules for the destination country. If the criteria at block 490 are satisfied, the third logic sequence may continue at block 492, where the ISO country code for the destination country and the phone number are saved to a results array. The third logic sequence may progress to block 494. The third logic sequence may also advance to block 494 if the criteria at block 490 are not satisfied.

At block 494, the app may determine if the current search is the last search. If the criterion at block 494 is satisfied, the third logic sequence may continue at block 496. If the current search is not the last search, the third logic sequence may continue at block 482 and another iteration of the loop may begin.

At block 496, the app may determine if a results array count is equal to zero. The results array count is the number of phone numbers saved to the results array during the iterations of the loop. The third logic sequence may advance to block 504 if the results array count equals zero.

The empty results array may indicate that the substrings of the phone number's beginning digits did not match any of the combinations of exit codes and entry codes in the database stored on the user's communication device. Consequently, the phone number cannot be reformatted by the third logic sequence. At block 504, the fourth logic sequence may be invoked in an attempt to reformat the phone number using the minimum, maximum, and verification rules for the user's current country. The fourth logic sequence is explained in detail with reference to FIG. 4E.

The third logic sequence may continue at block 498 if the results array count does not equal zero at block 496. At block 498, the app may determine if the results array count equals one. The third logic sequence may advance to block 500 if the results array contains a single phone number.

At block 500, the app may remove the substring from the beginning of the phone number. The substring may match a combination of an exit code and an entry code found in the database stored on the user's communication device. The substring may be the EDP for the phone number. The destination country may be determined from the entry code in the EDP. The phone number is converted to the TIN dialing format “ISO.number,” where “ISO” is the ISO country code for the destination country and “number” is the digits of the phone number that remain after the EDP has been removed.

The third logic sequence may continue at block 502 if the results array count is not equal to one at block 498. At block 502, multiple phone numbers found during the series of searches may be saved as an unresolved numbers array. The phone numbers in the unresolved numbers array are ambiguous; the first, second, and third logic sequences were unable to convert them to the TIN dialing format. Manual intervention is needed to reformat the unresolved phone numbers. Manual intervention is discussed in detail with reference to FIG. 4F.

FIG. 4E is a logic flow diagram of a fourth logic sequence of the reformatting sequence. The fourth logic sequence may convert domestic phone numbers to the global dialing format. The first, second, and third logic sequences may reformat international phone numbers. If a phone number has not been reformatted by the first, second, or third logic sequences, the phone number is most likely a domestic phone number and may be converted to the TIN dialing format by the fourth logic sequence.

At block 506, a record for the user's default (current) country may be accessed in the dialing codes database (excerpted in FIGS. 14A and 14B). The accessed record may indicate that the user's default country uses a domestic trunk. The domestic trunk may contain one to four digits that precede a domestic phone number. Some countries may use multiple domestic trunks. The terms “domestic trunk” and “local trunk prefix” may be used interchangeably.

At block 508, the app may determine if the dialing codes database indicates that the user's default country uses a domestic trunk. The fourth logic sequence may continue at block 510 if the criterion at block 508 is satisfied. Otherwise, the fourth logic sequence may continue at block 514.

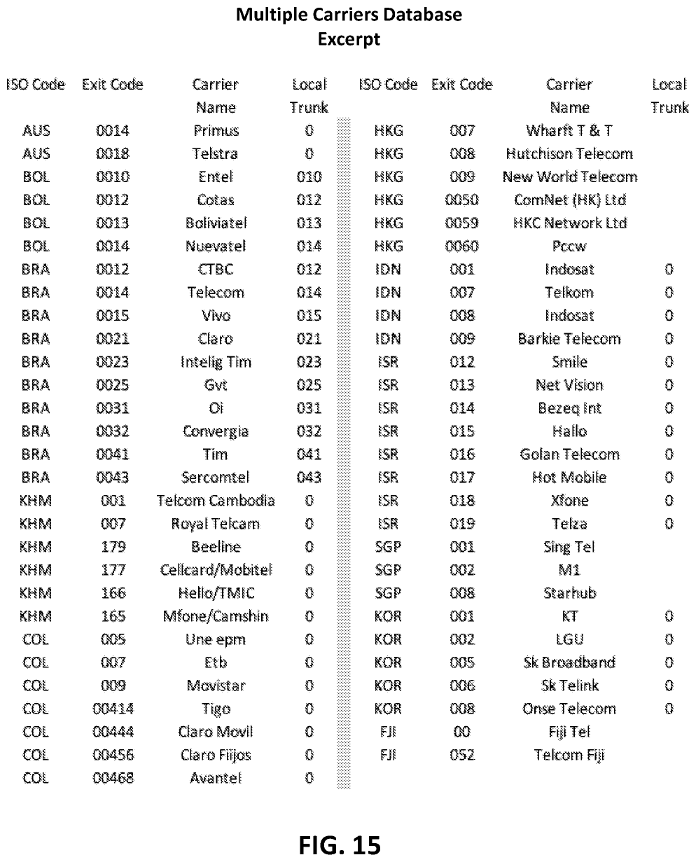

At block 510, the app may determine if the phone number to be reformatted begins with the domestic trunk for the user's default country. In some embodiments, a country may have one domestic trunk. The single domestic trunk may be determined from the dialing codes database. In other embodiments, a country may have two or more domestic trunks. For example, some countries may use one domestic trunk for dialing land lines and another for dialing mobile devices. Other countries may use different domestic trunks for dialing intra-city and inter-city phone numbers. Further, some countries may have different domestic trunks for different telecommunications carriers. For example, the database in FIG. 15 indicates that Brazil (BRA) has multiple telecommunications carriers and a different domestic trunk for each carrier.

The fourth logic sequence may continue at block 512 if the phone number to be reformatted begins with a domestic trunk for the user's default country. At block 512, the domestic trunk may be removed and the phone number may remain. Once the domestic trunk has been removed, the fourth logic sequence may advance to block 514. The fourth logic sequence may also advance to block 514 if the app determines at block 510 that the phone number does not begin with a domestic trunk for the user's default country.

Block 514 is a query concerned with the disposition of the phone number that remains after the domestic trunk has been removed. Specifically, this block may determine if the phone number conforms to the minimum, maximum, and verification rules for the user's default country. If unable to satisfy the criteria at block 514, the phone number may not be reformatted and becomes available for manual intervention at block 516.

The fourth logic sequence may progress from block 514 to block 518 if the remaining digits of the phone number conform to the minimum, maximum, and verification rules for the user's default country. At block 518, the remaining digits of the phone number may be reformatted. The remaining digits may be converted to the TIN dialing format “ISO.number,” where “ISO” is the ISO country code for the user's default country and “number” is the remaining digits of the phone number.

FIG. 4F is a logic flow diagram of a manual intervention sequence. Manual intervention may be used to convert an unresolved phone number to the TIN dialing format. An unresolved phone number could not be reformatted by the reformatting sequence.

At block 520, the app may initiate manual intervention when the user selects a phone number from the list of unresolved phone numbers displayed on the user's communication device. At block 522, the app may display the interface used to convert an unresolved phone number to the global dialing format. This interface is referred to as the edit screen. At block 524, the edit screen may allow the user to select the ISO country code for the destination country associated with the unresolved phone number. The selected ISO country code may be retrieved and saved.

The saved ISO code may be used to retrieve the minimum, maximum, and verification rules for the destination country. To retrieve the minimum and maximum rules, the ISO country code may be used to identify the destination country's record in the dialing codes database (excerpted in FIGS. 14A and 14B). The record for the destination country may be accessed and the minimum and maximum rules may be captured. To retrieve the verification sequences associated with the verification rule, the ISO country code may be used to identify the destination country's record in the verification database (excerpted in FIG. 13). The record for the destination country may be accessed and the verification sequences may be captured. Hence, the minimum, maximum, and verification rules for the destination country may be available for use at block 526.

At block 526, the app may determine if the unresolved phone number conforms to the captured minimum, maximum, and verification rules. The logic sequence may advance to block 536a if the criteria at block 526 are satisfied. At block 536a, the phone number may be converted to the TIN dialing format “ISO.number.” “ISO” is the ISO code selected by the user at block 524 and “number” is the phone number selected by the user at block 520.

The logic sequence may continue at block 528 if the phone number does not conform to the minimum, maximum, and verification rules for the destination country. At block 528, the app may suggest phone numbers by displaying the last digits of the unresolved phone number in strings of various lengths. The lengths of the strings may range from the minimum number of digits to the maximum number of digits specified in the minimum and maximum rules for the destination country. The user may select a suggested phone number.

At block 530, the app may determine if the user selected a suggested phone number at block 528. The logic sequence may continue at block 536b if a suggested phone number has been selected. At block 536b, the suggested phone number may be converted to the TIN dialing format “ISO.number,” where “ISO” is the ISO country code for the destination country and “number” is the suggested phone number selected by the user.

The logic sequence may continue at block 532 if the user has not selected a suggested phone number. At block 532, the app may allow the user to edit the unresolved phone number selected at block 520. The user may edit the phone number using the edit screen displayed on his or her communication device.

At block 534, the app may determine if the edited phone number conforms to the minimum, maximum, and verification rules for the destination country. The logic sequence may return to block 532 if the edited phone number does not satisfy the criteria at block 534. At block 532, the user may continue to edit the phone number. The logic sequence may continue at block 534, where the app may determine if the additional editing has resulted in a phone number that conforms to the minimum, maximum, and verification rules for the destination country. The logic sequence may once again return to block 532 if the phone number still fails to satisfy the criteria at block 534. Execution of blocks 532 and 534 may continue until the edited phone number conforms to the minimum, maximum, and verification rules for the destination country. The logic sequence may advance to block 536c once the edited phone number satisfies the criteria at block 534.

At block 536c, the logic sequence may reformat the conforming phone number. The phone number may be converted to the TIN dialing format “ISO.number,” where “ISO” is the ISO country code selected by the user and “number” is the edited phone number.

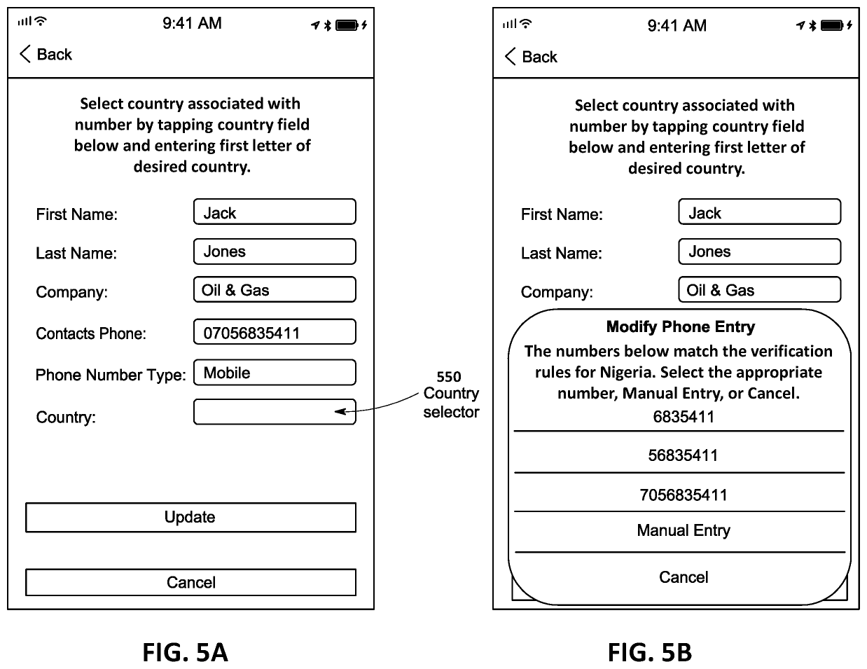

FIG. 5A is an illustration of a screen that appears on a user's communication device during the manual intervention sequence. The screen is one of a number of screens that may be displayed when user input is needed. The screen may allow the user to select the country associated with an unresolved phone number.

In the embodiment shown, the unresolved phone number “07056835411” needs to be converted to the TIN dialing format. Before conversion can occur, the user has to enter the country associated with the phone number. To accomplish this, the user taps the country field and enters the first letter of the associated country's name. A list of countries appears on the screen. The names of the listed countries all start with the same letter. The user scrolls through the list until the correct country appears in the country field. The user selects the correct country using the country selector 550. For example, Nigeria may be the country associated with the unresolved phone number “07056835411.” The user taps the country field and enters the letter “N.” The screen displays a list of the countries having names that begin with the letter entered by the user. The names of the various countries appear in the country field as the user scrolls through the list. Utilizing the country selector 550, the user selects “Nigeria” when it appears in the country field. The entry of “Nigeria” in the country field updates the record for Jack Jones.

FIG. 5B is an illustration of a screen that displays unresolved phone numbers. For example, Nigeria may have been selected using the country selector 550 shown in FIG. 5A. The screen in FIG. 5B displays stored phone numbers that conform to the minimum, maximum, and verification rules for Nigeria.

The user selects one of the phone numbers displayed on the screen. For example, the user may select the phone number “7056835411.” The selected phone number is converted to the TIN dialing format. The concatenation that results is “NGA.7056835411,” where “NGA” is the ISO country code for Nigeria and “7056835411” is the selected phone number. If the user does not select a displayed phone number, he or she may choose the manual entry option or the cancel option.

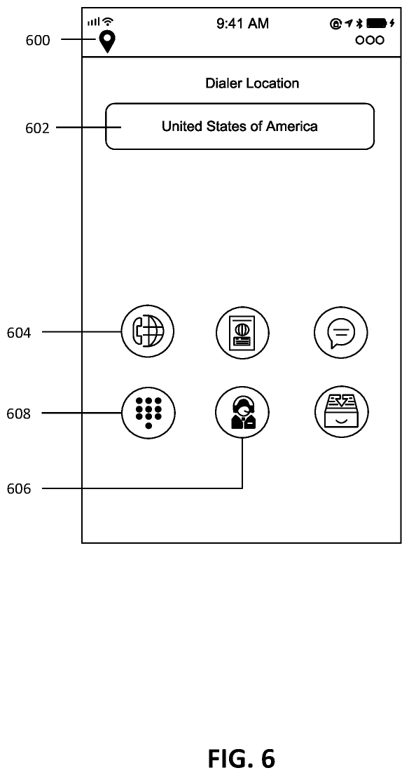

FIG. 6 is an illustration of a home screen that appears after launch of the app. The automatic country locator 600 may be a global positioning system (GPS) receiver that determines the country in which the user is currently located. The user's current country may be compared to the user's home country specified during installation of the app. If the countries match, the app may allow the user to make phone calls by selecting phone numbers from the compilation of global contacts 604 or by selecting the dialer 608.

The app may be unable to detect the user's location in the current country. This may occur if the automatic country locator 600 is not functioning. The user may compensate for the failure of the automatic country locator 600 by using the current location selector 602. The user may tap the current location selector 602, enter the first few letters of the name of the current country, and select the current country from the list that appears.

The dialing of international phone calls from a country other than the user's current country may be simulated using dial mode 606. For example, a user in the United States could simulate the dialing of international phone calls as if he or she were located in Germany. This feature allows the user to determine how the app would dial international phone numbers originating in different countries. Accordingly, the user can verify that the app dials international phone calls in accordance with the dialing protocols of different countries without leaving his or her current country.

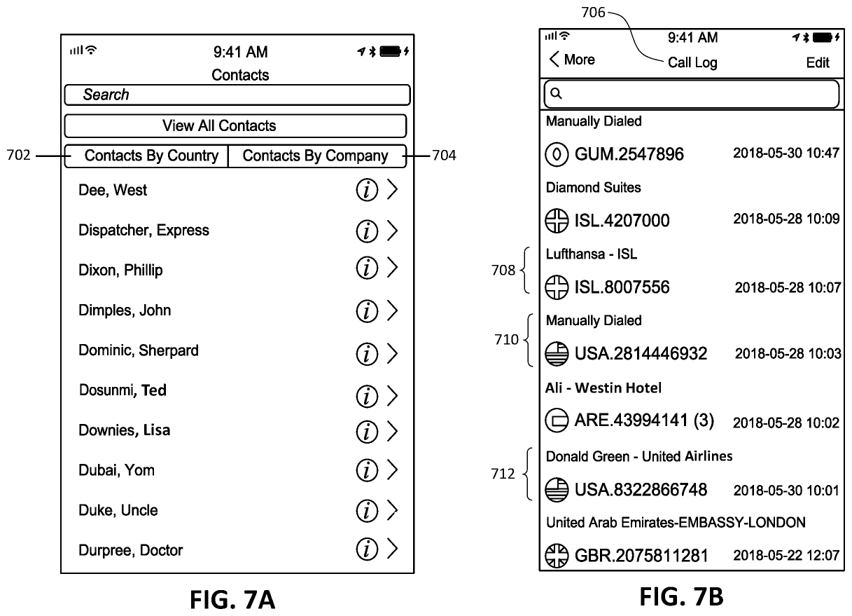

FIG. 7A is an illustration of a screen that allows a user to sort a contacts list on the user's communication device. If “Contacts by Country” 702 is selected, the screen displays the contacts grouped by country. If “Contacts by Company” 704 is chosen instead, the screen displays the contacts grouped by company.

FIG. 7B is an illustration of a screen that shows phone numbers saved to the user's call log in the TIN dialing format. Each phone number is displayed as a concatenation of the three-letter ISO country code for the destination country and the local phone number in the destination country. Further, each phone number may be preceded by an icon representing the destination country's flag. For example, the phone number for Donald Green 712 is a combination of the ISO country code for the United States “USA” and a ten-digit United States phone number “8322866748.” An icon representing the flag of the United States appears to the left of the TIN-formatted phone number.

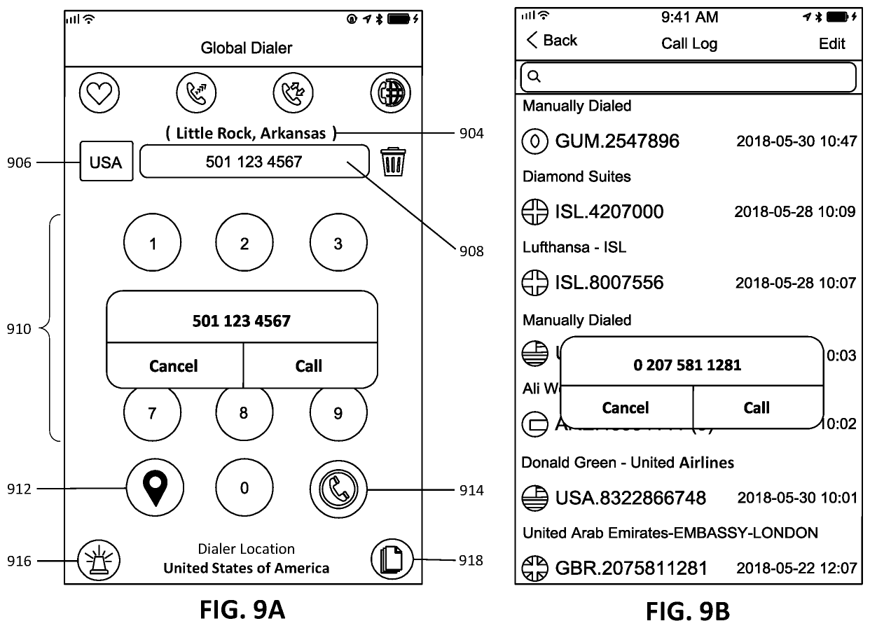

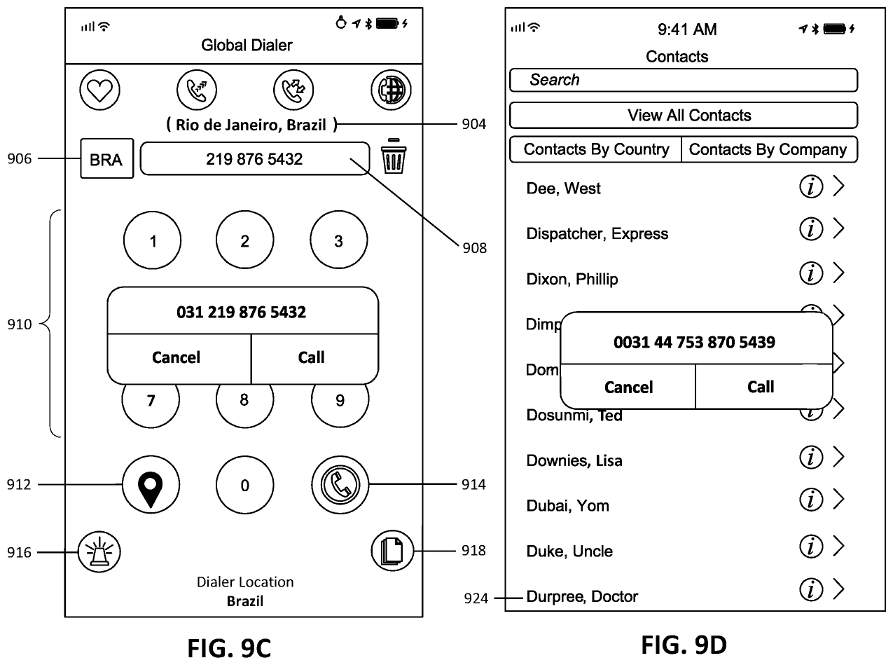

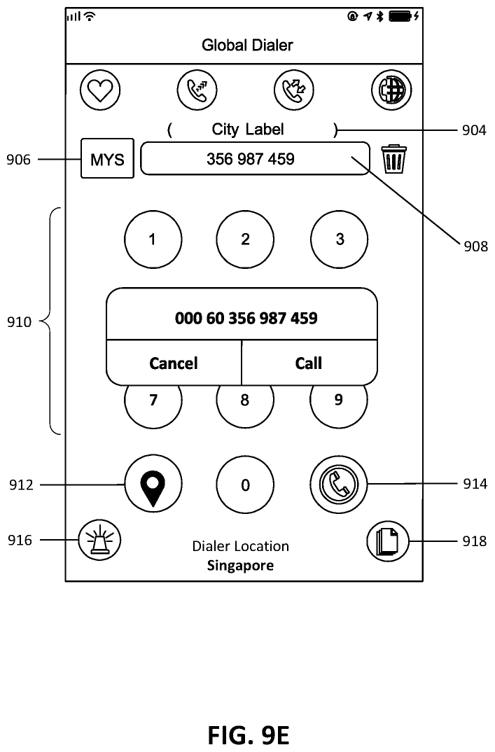

The call log 706 may display domestic and international phone numbers dialed from a communication device. The call log 706 may indicate when a phone number was called. A phone number may be followed by the date and time it was dialed. For example, Donald Green's phone number 712 was dialed on “2018-05-30” at “10:01.” In addition, the call log 706 may indicate how a phone number was dialed. For example, Donald Green's phone number 712 was dialed by selecting it from a contacts list stored on the communication device. Likewise, phone number 708 was dialed by selecting it from the contacts list. In contrast, phone number 710 was dialed manually using the TIN dialer shown in FIG. 9A.

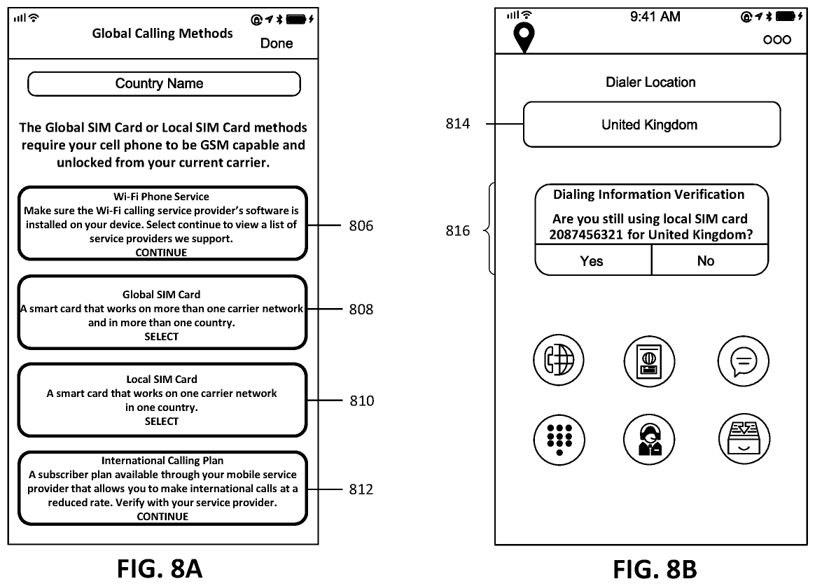

FIG. 8A is an illustration of a screen that shows global calling methods available on a communication device. The screen may appear when the app determines that the user's current country differs from his or her home country. The screen allows the user to select a method for calling TIN-formatted phone numbers saved on the user's communication device. The calling methods may include Wi-Fi phone service 806, global SIM card 808, local SIM card 810, and international calling plan 812.

Wi-Fi phone service 806 enables the user to call multiple countries by connecting his or her communication device to a Wi-Fi network. When Wi-Fi phone service 806 is selected, a list of Wi-Fi service providers is displayed. These service providers are supported by the user's wireless carrier. The global SIM card 808 is a smart card that allows the user to access multiple carrier networks in multiple countries. The international calling plan 812 is a subscriber plan available from a mobile service provider that permits the user to make international phone calls at reduced rates.

The local SIM card 810 is a smart card that allows the user to access a single carrier network in a certain area of the world. In some areas, each SIM provider (telecommunications carrier) has its own exit code. As a result, multiple exit codes may be used in these areas. Countries with multiple exit codes include Australia, Bolivia, Brazil, Cambodia, Chile, Colombia, Fiji, Finland, Georgia, Indonesia, Israel, Palau, Peru, Singapore, South Korea, and Thailand. Other areas having a number of exit codes include Hong Kong and Taiwan.

When a phone call is made from an area having multiple exit codes, a list of local telecommunications carriers may be displayed after the local SIM card 810 is selected from the screen shown in FIG. 8A. In an embodiment, the user may choose a carrier from the list. A database (excerpted in FIG. 15) is accessed to determine the exit code for the selected carrier.

FIG. 8B is an illustration of a screen that asks for verification of dialing information when a local SIM card option is selected. In an embodiment, the user may have traveled to the United Kingdom before and used a local SIM card to make domestic phone calls (i.e., the originating and destination countries are in the United Kingdom).

When the user returns to the UK, “United Kingdom” may appear in the dialer location field 814. The user's communication device may remember that a local SIM card was used during the user's previous visit to the United Kingdom. The communication device may display a query 816 asking if the user wants to use the same local SIM card during his or her current visit. If the user selects “Yes,” the local SIM card is once again the selected calling method. If the user selects “No,” he or she is returned to the screen shown in FIG. 8A. From this screen, the user may select a different calling method.

FIG. 9A is an illustration of a screen used to make a domestic phone call. In particular, this screen may be used to manually dial a domestic phone number. In an embodiment, a country selector 906 may default to the ISO country code for the user's current country. The user may dial a series of digits using a keypad 910. A number display 908 shows the series of digits if the series contains enough digits to satisfy the current country's dialing protocol. In FIG. 9A, a user located in the United States is making a domestic phone call. The series of digits dialed by the user “5011234567” appears in the number display 908 because the series has ten digits and satisfies the dialing protocol for the United States.

The communication device displays a notification if the user dialed a sufficient number of digits. The notification shows the series of digits and offers the user two options. The user selects “Call” if he or she dialed the correct phone number. The user selects “Cancel” if the series of digits does not constitute the intended phone number.

Other features of the screen include a city label 904 which may display the name of the city that is the destination of the phone call. The city label 904 may help the user determine if the phone number was dialed correctly. For example, if the user dials “5011234567,” the city label 904 may display “Little Rock, Arkansas.” If Little Rock is the intended destination, the user probably dialed the phone number correctly. In some countries, the city label 904 may display geographical areas instead of cities. In other countries, the app may distinguish between mobile devices and land lines. Accordingly, the device type may be displayed in the city label 904 along with the destination city.

A number of icons may appear on the screen. They may include an emergency number icon 916 and a phone directory icon 918. If the emergency number icon 916 is selected, the screen displays emergency numbers for the user's current location. If the phone directory icon 918 is selected, the screen displays a list of phone directories available in the current country. The user selects the appropriate phone directory from the list.

FIG. 9B is an illustration of a screen used to make phone calls from the call log on the user's communication device. In an embodiment, a user may travel to Great Britain and place a domestic phone call while there. The phone number the user intends to call may be saved to the call log in the TIN dialing format. The user may access the call log and select a previously dialed phone number “GBR.2075811281.” The phone number will be dialed using a domestic call logic because the user's current country is the same as the country corresponding to the ISO country code in the TIN-formatted phone number. The domestic call logic is initiated and an Internal Dialing Protocol (IDP) is concatenated with the local phone number. The IDP is a code dialed before domestic phone numbers. The local phone number to be called follows the ISO country code in the TIN-formatted phone number. The IDP for Great Britain is “0” and the domestic phone number is “2075811281.” The concatenation “02075811281” appears in the notification displayed on the screen. The series of digits in the concatenation is dialed if the user selects “Call.”

FIG. 9C is another illustration of a screen used to make a phone call. In particular, this screen may be used to manually dial a domestic phone number. In an embodiment, a user may travel to Sao Paulo, Brazil, and purchase a local SIM card while there. Brazil has multiple domestic carriers as shown in the multiple carriers database (excerpted in FIG. 15). Each carrier has its own local trunk (IDP).

The user may decide to make a domestic phone call to Rio de Janeiro. The user selects the local SIM card from the options displayed on the calling methods screen shown in FIG. 8A. The screen displays a list of the domestic carriers in Brazil. The user selects the carrier Oi from the list. As shown in the multiple carriers database (excerpted in FIG. 15), the local trunk for Oi is “031.” The user enters the domestic phone number “2198765432” using the keypad 910. To place the phone call, the user taps the dialer icon 914. The app initiates the domestic call logic because the user's current country and the destination country are the same. The app concatenates the local trunk for the selected carrier Oi “031” and the phone number in Rio de Janeiro “2198765432.” The concatenation “0312198765432” is called by the dialer if the user selects “Call” and is saved to the call log as “BRA.2198765432.”

The user may also initiate a phone call to Rio de Janeiro by selecting the international calling plan from the options displayed on the calling methods screen shown in FIG. 8A. The user enters the domestic phone number “2198765432” using the keypad 910. To place the phone call, the user taps the dialer icon 914. The app initiates the domestic call logic because the user's current country and the destination country are the same. The app concatenates the local trunk for the international calling plan “0” and the phone number in Rio de Janeiro “2198765432.” The concatenation “02198765432” is called by the dialer if the user selects “Call” and is saved to the call log as “BRA.2198765432.”

FIG. 9D is an illustration of a screen used to make phone calls from the contacts list. In an embodiment, a user located in Brazil may want to call Dr. Durpree 924 in the United Kingdom. The user has selected Brazilian carrier Oi as the telecommunications carrier for his or her communication device. Dr. Durpree's TIN-formatted phone number “GBR.7538705439” is saved as a contact phone number and Dr. Durpree's name appears on the contacts list. To place the phone call, the user taps Dr. Durpree's name. The app recognizes that the user is in Brazil and uses the telecommunications carrier Oi. Further, the app identifies Brazil as the origin of the phone call and the United Kingdom as the destination. The international call logic is initiated because the origin and destination countries are different. The app accesses the multiple carriers database (excerpted in FIG. 15) and determines that the exit code for the Brazilian carrier Oi is “0031.” The app also accesses the dialing codes database (excerpted in FIGS. 14A and 14B) and determines that the entry code for the United Kingdom is “44.” Therefore, the External Dialing Protocol (EDP) for the call from Brazil (Oi) to the United Kingdom is “003144.”

The app accesses the verification database (excerpted in FIG. 13) and compares the first few digits of Dr. Durpree's phone number to the verification sequences for the United Kingdom. If a match is found, the communication device calls “0031447538705439” if the user selects “Call” and the phone number is saved to the call log in the TIN dialing format “GBR.7538705439.”

FIG. 9E is an illustration of a global dialer interface used to make an international phone call. In an embodiment, a user located in Singapore decides to make a phone call to Malaysia. Before dialing the local phone number, the user selects international calling plan from the options displayed on the calling methods screen shown in FIG. 8A. As indicated by the number display 908, the local phone number in Malaysia is “356987459.”

The user's current country and the phone call's destination country have to be determined before the appropriate call logic can be invoked. The app may rely on the GPS receiver 912 to automatically identify the user's current country. Alternatively, the user may select his or her current country from a list displayed on the communication device. The app uses the ISO country code displayed by the country selector 906 to determine the destination country. In the present embodiment, the displayed ISO country code is “MYS.” The app accesses the dialing codes database (excerpted in FIGS. 14A and 14B) and determines that Malaysia is the country that corresponds to the ISO country code “MYS.” Hence, Malaysia is recognized as the destination country. Because the user's current country and the destination country are different, the exit code for Singapore “000” and the entry code for Malaysia “60” are retrieved from the dialing codes database (excerpted in FIGS. 14A and 14B). The verification database (excerpted in FIG. 13) is accessed and the app determines that the first few digits of the local phone number match a verification sequence for Malaysia. The exit code for Singapore, the entry code for Malaysia, and the local phone number are concatenated and the communication device calls “00060356987459” once the user has selected the “Call” option from the notification displayed on the screen. The phone number is saved to the call log in the TIN dialing format “MYS.356987459.”

FIG. 10A is a logic flow diagram of a call logic sequence used to call a phone number. Block 1000 indicates that the phone number to be dialed is a combination of “USA” and “5011234567” in the TIN dialing format. “USA” is the ISO country code for the United States and “5011234567” is a ten-digit U.S. phone number.

At block 1002, the app may determine if the ISO country code shown in block 1000 is the same as the ISO country code for the user's current country. The call logic sequence may continue at block 1004 if the ISO country codes are the same. At block 1004, the app may initiate a domestic (local) call logic sequence. At block 1006, the app may dial the concatenation of the IDP (if any) and the local phone number. The TIN-formatted phone number may be saved to the call log. Blocks 1004 and 1006 are explained in detail with reference to FIGS. 10B and 10BB.

In an embodiment, a user located in the United States may want to use his or her mobile phone to call the TIN-formatted phone number “USA.5011234567.” The ISO country code in the TIN-formatted phone number is the same as the ISO country code for the user's current country. Accordingly, the domestic call logic sequence is initiated. However, concatenation is not needed because there is no IDP for mobile phone calls made in the United States. The number “5011234567” is dialed as is and the TIN-formatted phone number is saved to the call log.

The call logic sequence may continue at block 1008 if the ISO country codes are not the same at block 1002. At block 1008, an international call logic sequence may be initiated. At block 1010, the concatenation of the EDP and the local phone number may be dialed. The TIN-formatted phone number may be saved to the call log. Blocks 1008 and 1010 are explained in detail with reference to FIGS. 10D and 10DD.

FIGS. 10B and 10BB are a logic flow diagram of a domestic call logic sequence. The user may select a TIN-formatted phone number to be dialed. The ISO country code for the destination country may be the same as the ISO country code for the user's current country. The matching ISO country codes may indicate that the user will be placing a domestic phone call. Accordingly, the domestic call logic sequence may be initiated.

At block 1012, the app may determine if the country uses domestic carrier codes. The domestic call logic sequence may continue at block 1014 if domestic carrier codes are used. The logic sequence may continue at block 1034 if domestic carrier codes are not used.

At block 1014, the app may determine if the user previously designated a default carrier. If so, the domestic call logic sequence may continue at block 1018. If not, the logic sequence may continue at block 1016, where the app may prompt the user to select a carrier and save it as the default carrier.

At block 1018, the app may determine if the default carrier utilizes different logic for intra-city and inter-city phone calls. In an embodiment, a user in Buenos Aires, Argentina, may select the local SIM card option from the calling methods screen shown in FIG. 8A. Phone calls made to Buenos Aires are intra-city phone calls. Phone calls made to other cities in Argentina are inter-city phone calls. Inter-city calls are also referred to as domestic long-distance phone calls. Some carriers use different logic for intra-city and inter-city phone calls.

The domestic call logic sequence may continue at block 1020 if the app determines at block 1018 that different dialing logic is used depending upon the destination city. The call logic sequence may continue at block 1026 if different logic is not used.

At block 1020, the app may determine if the phone call is an intra-city call. If an intra-city call is affirmed, the domestic call logic sequence may continue at block 1022. At block 1022, the app may extract the default carrier's intra-city code from a database stored on the user's communication device. The domestic call logic sequence may advance to block 1026.

If the phone call is not an intra-city call at block 1020, the call is an inter-city call and the domestic call logic sequence may continue at block 1024. At block 1024, the carrier's inter-city code may be extracted from the database stored on the user's communication device. The domestic call logic sequence may progress from block 1024 to block 1026.

The default carrier's intra-city code may be extracted from the database on the user's communication device at block 1022 and may be captured at block 1026. Alternatively, the default carrier's inter-city code may be extracted from the database at block 1024 and may be captured at block 1026. Once a carrier code has been captured, the domestic call logic sequence may progress to block 1048.

At block 1012, the app may have determined that the country does not use domestic carrier codes. If domestic carrier codes are not used, the domestic call logic sequence may continue at block 1034. At block 1034, the app may determine if the country uses a trunk prefix.

Trunk prefixes are used by more than 100 countries. The most common trunk prefixes are “1” for countries subscribing to the North American Numbering Plan (NANP), “8” for countries of the former Soviet Union, and “0” for the majority of European, African, Asian, Pacific, and Middle Eastern countries.

The domestic call logic sequence may continue at block 1036 if a trunk prefix is used. At block 1036, the app may determine if the country's trunk prefix differs depending upon the type of device called. Stated differently, the app may determine if the country uses different trunk prefixes for calls to mobile devices and calls to land lines.

In an embodiment, a user may travel to Argentina and decide to make a domestic phone call while there. To place the call, the user selects the local SIM card option from the calling methods screen shown in FIG. 8A. In Argentina, one trunk prefix is used for inter-city phone calls regardless of the type of device called. However, different trunk prefixes are used for intra-city phone calls. One trunk prefix is used if an intra-city phone call is made to a mobile device and another trunk prefix is used if an intra-city phone call is made to a land line. Thus, when the user places an intra-city phone call in Argentina, an alert appears on the screen of his or her communication device. The alert informs the user that Argentina uses different trunk prefixes for intra-city phone calls and prompts the user to select either the mobile device option or the land line option.

The domestic call logic sequence may progress from block 1036 to block 1042 if the app recognizes that the country uses different trunk prefixes. At block 1042, the app may access a database stored on the user's communication device and capture the trunk prefix for mobile devices or the trunk prefix for land lines. The domestic call logic sequence may continue at block 1048.

At block 1036, the app may determine that the country does not use different trunk prefixes for mobile devices and land lines. If this determination is made, the domestic call logic sequence may continue at block 1040. At block 1040, the app may determine if the country uses a single-digit trunk-await code. If such a code is used, the domestic call logic sequence may continue at block 1044.

At block 1044, the app may capture the single-digit code from the database stored on the user's communication device. The app may program the captured digit to pause dialing of a phone number for five seconds. For example, Belarus uses the digit “8” as the trunk-await code for domestic phone calls. In an embodiment, a user located in Belarus may decide to call the domestic phone number “256398752.” The app programs the digit “8” to pause dialing and concatenates it with the domestic phone number. When the concatenation “8256398752” is dialed, there is a five-second pause between the digit “8” and the digit “2” at the beginning of the domestic phone number. After the single digit has been programmed, the domestic call logic sequence may continue at block 1048.

At block 1040, the app may determine that the country does not use a single-digit trunk-await code. When this type of code is not used, the domestic call logic sequence may continue at block 1046. At block 1046, the country's trunk prefix may be captured from the dialing codes database (excerpted in FIGS. 14A and 14B). The domestic call logic sequence may continue at block 1048.

At block 1034, the app may recognize that the country does not use a trunk prefix. Accordingly, there is no trunk prefix to capture at block 1038 and the domestic call logic sequence may continue at block 1048.

Block 1048 may be reached from five blocks in the domestic call logic sequence. The blocks are 1026, 1038, 1042, 1044, and 1046. The answers to the various queries in the logic sequence determine which of these blocks immediately precedes block 1048. At block 1048, the user may dial the local phone number. The domestic call logic sequence may continue at block 1050.

At block 1050, the app may determine if the local phone number satisfies the verification logic sequence. The verification logic sequence involves the comparison of the first few digits of the local phone number to the country's verification sequences found in the verification database (excerpted in FIG. 13). The verification logic sequence is explained in detail with reference to FIG. 10C.

If the first few digits of the local phone number match a verification sequence, the phone number may satisfy the verification logic sequence and the domestic call logic sequence may continue at block 1052. If the first few digits of the local phone number do not match a verification sequence, the phone number may not satisfy the verification logic sequence and the domestic call logic sequence may continue at block 1054, where the dialer resets.

At block 1052, the destination city for the dialed phone number may be displayed in the city label field 904 on the global dialer screen shown in FIG. 9A. The domestic call logic sequence may continue at block 1056. At block 1056, the app may determine if the local phone number satisfies the digit count sequence. The local phone number may be compared to the country's minimum and maximum rules (MMR) found in the dialing codes database (excerpted in FIGS. 14A and 14B). The minimum and maximum rules specify the minimum and maximum number of digits contained in the country's phone numbers. The domestic call logic sequence may continue at block 1058 if the local phone number has an appropriate number of digits. If the local phone number has too few or too many digits, the domestic call logic sequence may continue at block 1054, where the dialer resets.

At block 1058, the dialer may concatenate any captured code or prefix and the dialed phone number and a domestic concatenation may result. The captured code may be a domestic carrier code, carrier intra-city code, carrier inter-city code, or single-digit trunk-await code. The captured prefix may be a trunk prefix, mobile-device trunk prefix, or land-line trunk prefix. Alternatively, the app may not capture a code or prefix. This occurs when the country does not use a domestic carrier code at block 1012 and does not use a trunk prefix at block 1034. Accordingly, the local phone number may remain unchanged and is saved and called at subsequent blocks in the domestic call logic sequence (provided the local number matches a verification sequence at block 1050 and satisfies the MMR at block 1056).

The domestic call logic sequence may continue at block 1060. At block 1060, the TIN-formatted phone number may be saved to the call log. The domestic concatenation or the local phone number may be called.

FIG. 10C is a logic flow diagram of a phone number verification logic sequence. In particular, FIG. 10C illustrates the logic sequence used to determine if a phone number matches a verification sequence at block 1050 in FIG. 10BB (domestic call logic sequence) or at block 1130 in FIG. 10DD (international call logic sequence). A user starts to dial a phone number and the verification logic sequence may commence at block 1064.

At block 1064, the app may determine if the sixth digit of the phone number has been entered. If the sixth digit has been entered, the verification logic sequence may advance from block 1064 to block 1062. If fewer than six digits have been dialed, the user may continue to dial at block 1066 using the keypad 910 shown in FIG. 9A. The user may add digits to the phone number until the sixth digit has been entered. Once six digits have been dialed, the verification logic sequence may advance from block 1064 to block 1062.

At block 1062, the app may determine if the user is making a domestic phone call. The app may compare the user's current country to the country corresponding to the ISO country code displayed in the country selector field 906 on the global dialer screen shown in FIG. 9A. If the countries are the same, the user is making a domestic call and the verification logic sequence may continue at block 1068. At block 1068, the app may capture the entry code for the current country from the dialing codes database (excerpted in FIGS. 14A and 14B). The verification logic sequence may continue at block 1072.

At block 1072, the app may determine if the domestic phone call is toll-free. If the phone call is toll-free, the verification logic sequence may continue at block 1080. At block 1080, the search predicate may be modified to restrict the search of the verification database at block 1078 to validation entries for toll-free calls. Stated differently, the app will only search the toll-free validation entries in the database, not the entire database. Once the search predicate has been changed, the verification logic sequence may continue at block 1074. The verification logic sequence may also continue at block 1074 if the app determines at block 1072 that the domestic phone call is not toll-free.

At block 1062, the app may determine that the user is not making a domestic phone call. As discussed above, the app may determine the type of the phone call (domestic or international) by comparing the user's current country to the country corresponding to the ISO country code displayed in the country selector field 906 shown in FIG. 9A. If the countries are not the same, the user is making an international phone call and the verification logic sequence may continue at block 1070. At block 1070, the app may capture the entry code for the destination country from the dialing codes database (excerpted in FIGS. 14A and 14B). The verification logic sequence may continue at block 1074 after the entry code is captured.

At block 1074, the app may combine one of two codes and the six digits dialed by the user. The code may be the entry code for the current country captured at block 1068 or the entry code for the destination country captured at block 1070. The captured code and the six dialed digits may be combined to create a verification string. The verification logic sequence may continue at block 1076 after the verification string has been created. At block 1076, a loop counter is set to one before a validation loop begins at block 1078.

At block 1078, the app may search the verification database for a validation entry that matches the verification string. If the call is toll-free, the app only searches the toll-free verification codes for a matching validation entry. The verification logic sequence may continue at block 1082, where the app may determine if a matching validation entry has been found. The verification logic sequence may continue at block 1084 if the verification database contains a validation entry that matches the verification string.

At block 1084, the description associated with the matching validation entry may be captured from the verification database and displayed in the city label field 904 shown in FIG. 9A. Once the city label field is updated, the verification logic sequence may advance to block 1094, where the user may continue dialing the phone number.

The verification logic sequence may continue at block 1090 if the app determines at block 1082 that the verification database does not contain a validation entry that matches the verification string. At block 1090, the app may determine if the loop counter is equal to six. If the loop counter is less than six, the verification logic sequence may continue at block 1088. At block 1088, the app may reduce the number of digits in the verification string by the value of the loop counter. Once the verification string has been shortened, the verification logic sequence may continue at block 1086, where the loop counter may be incremented by one. The verification logic sequence may continue at block 1078 after the loop counter has been updated.

At block 1078, the app may search the verification database for a validation entry that matches the shortened verification string. The validation loop composed of blocks 1078, 1082, 1090, 1088, and 1086 may iterate until a matching validation entry is found at block 1082 or until the loop counter is equal to six at block 1090. The verification logic sequence may continue at block 1092 once the loop counter equals six. At block 1092, the app may display an alert on the global dialer screen shown in FIG. 9A. The alert reads “Phone number does not match validation entries.” This message informs the user that the six dialed digits do not match any of the validation entries in the verification database (excerpted in FIG. 13). In short, the six digits do not constitute the beginning digits of a valid phone number.

The logic sequence may resume at block 1096, where the app may determine if the user is attempting to continue dialing. The app may present the user with an option to continue and an option to discontinue dialing of the phone number. If the user elects to continue, the logic sequence may advance to block 1094, where the app may allow the user to continue dialing. The user may opt to continue dialing even though the validation loop failed to find a validation entry that matches the beginning digits of the phone number. If the user elects to discontinue dialing, the logic sequence may advance to block 1098, where the app resets the dialer.

FIGS. 10D and 10DD are a logic flow diagram of an international call logic sequence. The user selects the TIN-formatted phone number to be called. At block 1100, the ISO country code for the destination country does not match the ISO country code for the user's current country. The different ISO country codes indicate that the user will be placing an international phone call. Accordingly, the international call logic sequence may be initiated at block 1102. The logic sequence begins at block 1108.

At block 1108, the app may determine if the current country and the destination country are members of the same telecommunications alliance. To make this determination, the app may access the dialing codes database (excerpted in FIGS. 14A and 14B). For example, the North American Numbering Plan (NANP) is an alliance that includes countries in North America and the Caribbean and territories of the United States. The East African Telephone Numbering Plan is another example of a telecommunications alliance. The members of this alliance are Tanzania, Uganda, and Kenya.

The international call logic sequence may continue at block 1110 if the current country and the destination country are members of the same alliance. At block 1110, alliance rule logic may be used to capture an alliance dialing code from the dialing codes database (excerpted in FIGS. 14A and 14B). The captured alliance dialing code may be a first external dialing protocol (EDP) string. Alliance rule logic is explained in detail with reference to FIG. 10E. The international call logic sequence may continue at block 1128.

If the current country and the destination country are not members of the same telecommunications alliance, the international call logic sequence may advance from block 1108 to block 1112. At block 1112, the app may determine if the current country uses international carrier codes. The international call logic sequence continues at block 1114 if international carrier codes are used by the current country. At block 1114, the appropriate international carrier code may be captured from a database stored on the user's communication device. Once the international carrier code is captured, the international call logic sequence continues at block 1122.

If the current country does not use international carrier codes, the international call logic sequence may advance from block 1112 to block 1116. At block 1116, the app may determine if the current country uses a single-digit await code followed by an exit code. The international call logic sequence continues at block 1118 if the current country's single-digit await code precedes its exit code.

At block 1118, the dialing codes database may be accessed and the current country's single-digit await code and exit code may be captured. The single-digit await code may be programmed to pause dialing for five seconds. In an embodiment, the dialer may dial the single-digit await code. After a five-second pause, the dialer may resume dialing and dial the exit code. For example, the single-digit await code and the exit code for Belarus are “8” and “10,” respectively. If a user makes an international phone call from Belarus, the dialer dials “8” and dialing pauses for five seconds. After the pause, the dialer resumes dialing and dials “10,” the entry code for the destination country, and the local phone number. The international call logic sequence may continue at block 1122 after the single-digit await code and exit code are captured.

At block 1116, the app may determine that the current country does not use a single-digit await code before the country's exit code. If a single-digit await code is not used, the international call logic sequence may continue at block 1120. At block 1120, the current country's exit code is captured from the dialing codes database (excerpted in FIGS. 14A and 14B). The international call logic sequence may continue at block 1122 after capture of the exit code.

At this point in the international call logic sequence, the app may have captured an international carrier code at block 1114, the single-digit await code and the exit code at block 1118, or the exit code at block 1120. The captured code constitutes the current country's EDP, a component of the complete EDP for the international phone call. The current country's EDP is the exit-code portion of the complete EDP. At subsequent blocks in the international call logic sequence, the app will append the entry code(s) for the destination country to the current country's EDP. Together, the current country's EDP and the destination country's entry code(s) form the complete EDP.

At block 1122, the app may determine if the destination country uses different entry codes for mobile devices and land lines. The international call logic sequence continues at block 1124 if different entry codes are used. At block 1124, the app may use mobile-device entry code logic or land-line entry code logic to capture the appropriate entry code from a database that includes mobile-device entry codes and land-line entry codes for various countries. The app may join together the current country's EDP, the destination country's entry code, and the mobile-device entry code or the land-line entry code. The resulting series of digits is a second EDP string. After the second EDP string is formed, the international call logic sequence may continue at block 1128.

At block 1122, the app may determine that the destination country does not use different entry codes for mobile devices and land lines. The international call logic sequence continues at block 1126 if different entry codes are not used. At block 1126, the app may combine the current country's EDP and the destination country's entry code. The resulting series of digits is a third EDP string. After the third EDP string is formed, the international call logic sequence may continue at block 1128.

At block 1128, the user may dial the local phone number in the destination country. The international call logic sequence may continue at block 1130 once the local phone number has been dialed.

At block 1130, the app may determine if the dialed phone number satisfies a verification logic sequence. The verification logic sequence involves comparing the first few digits of the dialed phone number to the destination country's verification sequences found in the verification database (excerpted in FIG. 13). The verification logic sequence is explained in detail with reference to FIG. 10C.

If the first few digits of the dialed phone number match a verification sequence, the phone number satisfies the verification logic sequence and the international call logic sequence continues at block 1136. If the first few digits of the dialed phone number do not match a verification sequence, the phone number does not satisfy the verification logic sequence and the international call logic sequence may continue at block 1134, where the dialer resets. After the dialer resets, the international call logic sequence may continue at block 1128. At block 1128, the user may re-dial the local phone number. Blocks 1130, 1134, and 1128 are repeated until the user dials a phone number that satisfies the verification logic sequence. Once the verification logic sequence is satisfied, the international call logic sequence may continue at block 1136. At block 1136, the destination city for the dialed phone number is displayed in the city label field 904 shown in FIG. 9A. The international call logic sequence may continue at block 1132.

At block 1132, the app may determine if the dialed phone number satisfies the destination country's minimum and maximum rules (MMR) found in the dialing codes database (excerpted in FIGS. 14A and 14B). The minimum and maximum rules specify the minimum and maximum number of digits contained in a country's phone numbers. The app may compare the number of digits in the dialed phone number to the MMR for the destination country. If the dialed phone number has an appropriate number of digits, the international call logic sequence may continue at block 1138.

If the dialed phone number has too few or too many digits, the international call logic sequence may continue at block 1134, where the dialer resets. After the dialer resets, the international call logic sequence may continue at block 1128. At block 1128, the user may re-dial the local phone number. Blocks 1132, 1134, 1128, 1130, and 1136 are repeated until the user dials a phone number that has an appropriate number of digits. Once the minimum and maximum rules are satisfied, the international call logic sequence may continue at block 1138.

At block 1138, the dialer may concatenate an EDP string and the dialed local phone number. The EDP string may be the first EDP string obtained at block 1110, the second EDP string obtained at block 1124, or the third EDP string obtained at block 1126. The EDP string consists of a series of digits determined by the answers to the sequence of questions at blocks 1108, 1112, 1116, and 1122. The first EDP string may be the captured alliance dialing code. The third EDP string may contain the current country's EDP plus the destination country's entry code. The second EDP string may contain the third EDP string plus the captured mobile-device entry code or the captured land-line entry code. The EDP string may be concatenated with the dialed local phone number to form an international concatenation.

Once concatenation has occurred, the international call logic sequence may continue at block 1140. At block 1140, the TIN-formatted phone number may be saved to the call log. At block 1142, the international call logic sequence may call the international concatenation.

FIG. 10E is a logic flow diagram of an alliance rule logic sequence. The logic sequence is used at block 1110 in FIG. 10D to capture the alliance dialing code. The logic sequence may begin at block 1150.

At block 1150, a common alliance may be found by accessing the dialing codes database (excerpted in FIGS. 14A and 14B) and comparing the records for the international phone call's originating country and destination country. The app may determine that the originating and destination countries are members of the same telecommunications alliance if the records for both countries contain a reference to the alliance. For example, if a user in the Bahamas selects Barbados and a local phone number to be dialed, the app accesses the dialing codes database, compares the records for the Bahamas and Barbados, and determines that both countries are members of the North American Numbering Plan (NANP) alliance.

The alliance rule logic sequence may continue at block 1152 if a common alliance is identified. At block 1152, an alliance dialing code may be captured from the destination country's record. The alliance rule logic sequence may continue at block 1154 once the alliance dialing code has been captured.

At block 1154, the user may dial the local phone number in the destination country. The alliance rule logic sequence may continue at block 1156, where the app determines if the dialed phone number satisfies the verification logic sequence. The logic sequence may compare the first few digits of the dialed local phone number to the destination country's verification sequences found in the verification database (excerpted in FIG. 13). The verification logic sequence is explained in detail with reference to FIG. 10C.

The verification logic sequence is satisfied if the first few digits of the dialed local phone number match a verification sequence. If a match is found, the alliance rule logic sequence may continue at block 1158. If a match is not found, the dialed phone number does not satisfy the verification logic sequence and the alliance rule logic sequence may continue at block 1160, where the dialer resets. The alliance rule logic sequence may advance from block 1160 to block 1154. At block 1154, the user may re-dial the phone number. Blocks 1156, 1160, and 1154 may be repeated until the user dials a local phone number that satisfies the verification logic sequence. The alliance rule logic sequence may continue at block 1158 once the verification logic sequence is satisfied. At block 1158, the destination city for the dialed local phone number is displayed in the city label field 904 shown in FIG. 9A. The alliance rule logic sequence may continue at block 1162.

The digit count sequence may take place at block 1162. The app may determine if the dialed local phone number conforms to the destination country's minimum and maximum rules (MMR) found in the dialing codes database (excerpted in FIGS. 14A and 14B). The MMR specify the minimum and maximum number of digits contained in a country's local phone numbers. The app may compare the number of digits in the dialed local phone number to the MMR for the destination country. If the dialed phone number has an appropriate number of digits, the alliance rule logic sequence continues at block 1164.

If the dialed phone number has too few or too many digits, the alliance rule logic sequence may continue at block 1160, where the dialer resets. The alliance rule logic sequence may continue at block 1154. At block 1154, the user may re-dial the local phone number. Blocks 1162, 1160, 1154, 1156 and 1158 are repeated until the user dials a local phone number that has an appropriate number of digits. Once the minimum and maximum rules are satisfied, the alliance rule logic sequence continues at block 1164.

At block 1164, the captured alliance dialing code (first EDP string) may be concatenated with the dialed local phone number to form an alliance concatenation. The alliance rule logic sequence may continue at block 1166, where the TIN-formatted phone number is saved to the call log. At block 1168, the alliance rule logic sequence may call the alliance concatenation.

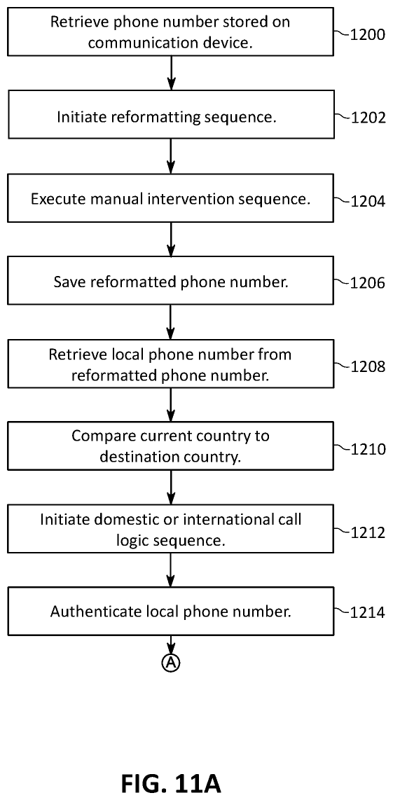

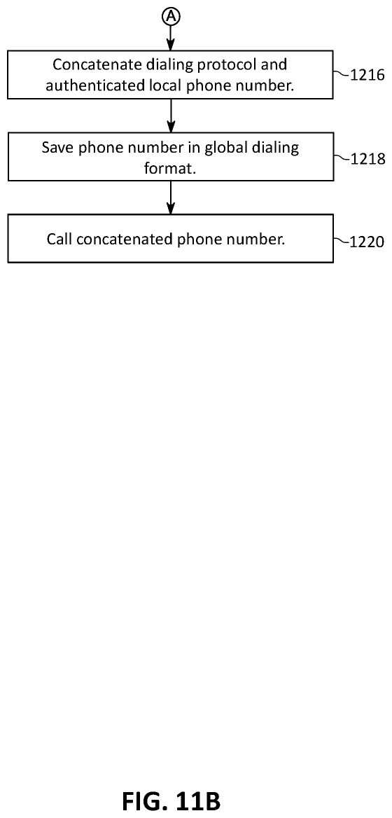

FIGS. 11A and 11B are a process flow diagram of a method for using a global dialing format. The method may be performed when the logic sequence shown in FIG. 1 is implemented as instructions that are read and executed by at least one processor.

At block 1200, a phone number stored on a communication device may be retrieved. At block 1202, a reformatting sequence may be initiated. The reformatting sequence may convert the retrieved phone number to the global dialing format “ISO.number,” where “ISO” is the three-letter ISO country code for the destination country and “number” is the local phone number in the destination country.

The reformatting sequence may be composed of four logic sequences shown in FIGS. 4B and 4BB, 4C and 4CC, 4D and 4DD, and 4E. The retrieved phone number may be reformatted by one of the four logic sequences. However, the four logic sequences may be unable to convert some retrieved phone numbers to the global dialing format. When this occurs, a user may intervene. At block 1204, a manual intervention sequence may be executed. The manual intervention sequence may allow the user to intercede and reformat the retrieved phone number. At block 1206, the reformatted phone number may be saved to a global contacts list on the communication device. The phone number is saved whether it was converted to the global dialing format by the reformatting sequence or the manual intervention sequence.

At block 1208, the local phone number may be retrieved from the reformatted phone number saved on the communication device. Block 1208 may begin the conversion of the saved phone number to a dialable format. This conversion may be initiated when the user decides to dial the saved number and chooses it from a list of phone numbers stored on the communication device.

At block 1210, the user's current country may be compared to the destination country. The user's current country may be the same as the country in which the communication device is located. The destination country may be the country corresponding to the ISO country code in the saved phone number. A domestic call logic sequence may be initiated at block 1212 if the user's current country and the destination country are the same. An international call logic sequence may be initiated at block 1212 if the two countries are different. Whether domestic or international, the call logic sequence may determine the dialing codes and prefixes necessary to complete the call to the local phone number. The domestic call logic sequence is shown in FIGS. 10B and 10BB and the international call logic sequence is shown in FIGS. 10D and 10DD.

At block 1214, the local phone number may be authenticated. The authentication process determines if the local phone number is an actual phone number in the destination country. Authentication may be a two-step process. The first step may be a verification process which compares the first few digits of the local phone number to sequences of digits that begin phone numbers in the destination country. The second step may be a digit count process which determines if the local phone number has an appropriate number of digits for phone numbers in the destination country. An authenticated local phone number may satisfy both the verification process and the digit count process.

At block 1216, the authenticated local phone number may be concatenated with a dialing protocol. The dialing protocol may contain the dialing codes and prefixes required to call the local phone number. The dialing codes and prefixes may have been identified and captured during the call logic sequence initiated at block 1212. In an embodiment, the exit code for the originating country and the entry code for the destination country may constitute the dialing protocol that is combined with the local phone number. The concatenation of the dialing protocol and the local phone number may result in a concatenated phone number. At block 1218, the retrieved phone number may be saved to the call log in the global dialing format. The concatenated phone number may be called at block 1220.

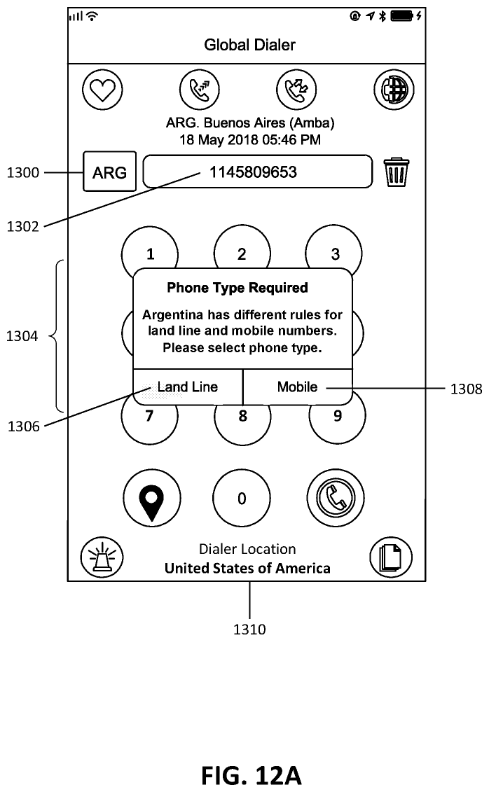

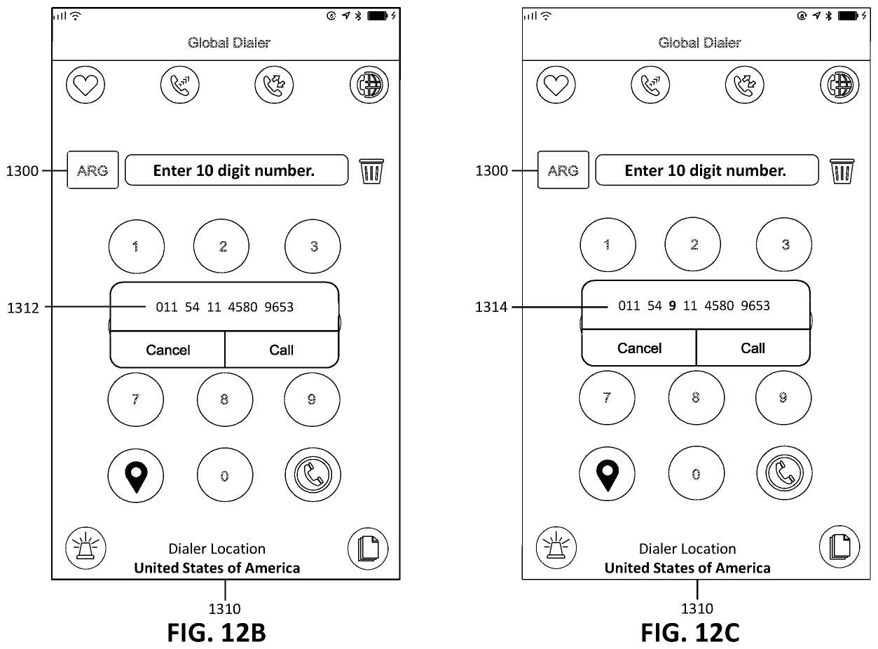

A small number of countries have different conventions for incoming international calls to land lines and incoming international calls to mobile devices. Argentina is one such country. FIG. 12A is an illustration of a screen used to initiate an international phone call to Argentina. In FIG. 12A, the user is calling Argentina from the United States. The dialer location 1310 indicates that the United States is the originating country. The ISO country code “ARG” 1300 signifies that Argentina is the destination country. The local phone number to be called is shown in the number display field 1302.

After the local phone number is dialed, an alert 1304 appears on the global dialer screen. The alert 1304 reads “Argentina has different rules for land line and mobile numbers. Please select phone type.” In an embodiment, the user may be placing an international phone call to a land line in Argentina. The user selects the option “Land Line” 1306 from the alert 1304. Argentina does not require the addition of a land-line entry code to an international phone number when a land line is called. This is shown in FIG. 12B. In another embodiment, the user may be placing an international phone call to a mobile device in Argentina. If so, the user selects the option “Mobile” 1308 from the alert 1304. Argentina does require the addition of a mobile-device entry code to an international phone number when a mobile device is called. The entry code for mobile devices is inserted into the international phone number after the entry code for Argentina and before the local phone number. This is shown in FIG. 12C.

FIG. 12B is an illustration of a screen used to make an international phone call to a land line in Argentina. As in FIG. 12A, the dialer location 1310 indicates that the United States is the originating country and the ISO country code “ARG” 1300 signifies that Argentina is the destination country. The screen in FIG. 12B appears after the user selects the option “Land Line” from the screen shown in FIG. 12A. In FIG. 12B, the international phone number 1312 includes the exit code “011” for the United States and the entry code “54” for Argentina. No land-line entry code is inserted between the entry code for Argentina and the local phone number “1145809653” because Argentina does not require the addition of a land-line entry code. The international phone number may be saved to the call log as “ARG.1145809653.” The type of destination device (land line) is also saved to the call log.

FIG. 12C is an illustration of a screen used to make an international phone call to a mobile device in Argentina. The screen in FIG. 12C appears after the user selects the option “Mobile” from the screen shown in FIG. 12A. In FIG. 12C, the international phone number 1314 includes the mobile-device entry code “9” inserted between the entry code for Argentina “54” and the local phone number “1145809653” because Argentina requires the addition of a mobile-device entry code. The international phone number may be saved to the call log as “ARG.1145809653.” The type of destination device (mobile) is also saved to the call log.

The embodiments disclosed herein may be implemented as instructions stored on a tangible, non-transitory, machine-readable medium. These instructions may be read and executed by a computing platform to perform the functions described above. A tangible, non-transitory, machine-readable medium may include any tangible, non-transitory medium for storing information in a form readable by a machine, e.g., a computer. Examples of a tangible, non-transitory, machine-readable medium may include read only memory (ROM), random access memory (RAM), magnetic disk storage media, optical storage media, flash memory devices, or the like.

An embodiment is an implementation or example. Reference to “an embodiment,” “present embodiment,” “some embodiments,” or “other embodiments” means that a particular function or feature is included in at least some embodiments, but not necessarily all embodiments. The various occurrences of “an embodiment” or “some embodiments” are not necessarily all referring to the same embodiments. Not all functions and features described and illustrated herein need be included in a particular embodiment or embodiments.

Some embodiments have been described in reference to particular implementations. However, other implementations are possible. The implementations of the present techniques are not limited to those disclosed herein. Additionally, the sequence of the functions and the arrangement of the features described above or illustrated in the drawings need not be sequenced or arranged in the particular way described or illustrated. Other sequences or arrangements are possible.

Elements shown in the drawings may have the same reference number or different reference numbers to suggest that the elements are similar or different. However, an element may be flexible enough to be present in some or all of the implementations described above or shown in the drawings.

Details of an aforementioned example may apply to one or more embodiments. Further, the embodiments of the present techniques are not limited to those embodiments described herein or shown in the drawings. Logic flow diagrams and process flow diagrams have been used herein to illustrate embodiments. However, the present techniques are not limited to those diagrams or to the corresponding descriptions. For example, the sequences and processes exemplified in the diagrams need not progress through each box shown or in exactly the same order as illustrated.

The present techniques are not restricted to the particular details described herein. Those skilled in the art having the benefit of this disclosure will appreciate that many other variations of the foregoing description and accompanying drawings are possible and remain within the scope of the present techniques. Accordingly, the scope of the present techniques is defined by the following claims and any amendments thereto.

What is claimed is:

1. At least one non-transitory computer-readable medium, comprising instructions to direct at least one processor to:
retrieve a phone number stored on a communication device;
initiate a reformatting sequence to reformat the phone number, wherein the reformatting sequence comprises a first logic sequence, a second logic sequence, a third logic sequence, and a fourth logic sequence;
enable a manual intervention sequence when the reformatting sequence is unable to reformat the phone number;
save a reformatted phone number to the communication device, wherein the reformatted phone number is in a global dialing format and wherein the reformatted phone number is obtained from the reformatting sequence or from the manual intervention process;
retrieve a local phone number from the reformatted phone number when a user selects the reformatted phone number;
initiate a domestic call logic sequence or an international call logic sequence;
execute an authentication process, wherein an authenticated local phone number is obtained and wherein the authentication process comprises a verification process and a digit count process;
concatenate a dialing protocol and the authenticated local phone number, wherein a concatenated phone number is obtained;
save the phone number to a call log on the communication device, wherein the phone number is saved in the global dialing format; and
call the concatenated phone number.

2. The at least one non-transitory computer-readable medium of claim 1, wherein the reformatted phone number is a concatenation of a standardized country code and the local phone number and wherein the local phone number is in a destination country represented by the standardized country code.

3. The at least one non-transitory computer-readable medium of claim 2, wherein the standardized country code in the reformatted phone number is a three-letter code for the destination country.

4. The at least one non-transitory computer-readable medium of claim 3, wherein the three-letter code is an International Organization for Standardization (ISO) country code for the destination country.

5. The at least one non-transitory computer-readable medium of claim 1, comprising instructions to:
initiate the first logic sequence of the reformatting sequence when the phone number begins with a “+” symbol;
remove the “+” symbol, wherein a first remainder of the phone number is obtained;
set a first loop counter equal to five;
begin a first loop;
set a first number of digits in a first beginning series of digits in the first remainder of the phone number equal to the first loop counter;
remove the first beginning series of digits from the first remainder of the phone number, wherein a first remaining series of digits is obtained;
determine if a first set of criteria is satisfied, wherein the first set of criteria is satisfied when the first beginning series of digits matches a first entry code for a first destination country and the first remaining series of digits conforms to a first minimum rule, a first maximum rule, and a first verification rule for the first destination country,
wherein if the first set of criteria is satisfied,
reformat the phone number, wherein a first reformatted phone number is obtained and wherein the first reformatted phone number is a first concatenation of a first standardized country code for the first destination country and the first remaining series of digits;
save the first reformatted phone number to the communication device;
wherein if the first set of criteria is not satisfied,
decrement the first loop counter by one;
repeat the first loop until the first reformatted phone number is saved to the communication device or until five iterations of the first loop are complete; and
proceed to initiate the second logic sequence of the reformatting sequence when five iterations of the first loop are complete.

6. The at least one non-transitory computer-readable medium of claim 1, comprising instructions to:
initiate the second logic sequence of the reformatting sequence when the phone number begins with a first exit code for a first current country, wherein the user is located in the first current country;
remove the first exit code, wherein a second remainder of the phone number is obtained;
set a second loop counter equal to five;
begin a second loop;
set a second number of digits in a second beginning series of digits in the second remainder of the phone number equal to the second loop counter;
remove the second beginning series of digits from the second remainder of the phone number, wherein a second remaining series of digits is obtained;
determine if a second set of criteria is satisfied, wherein the second set of criteria is satisfied when the second beginning series of digits matches a second entry code for a second destination country and the second remaining series of digits conforms to a second minimum rule, a second maximum rule, and a second verification rule for the second destination country;
wherein if the second set of criteria is satisfied,
reformat the phone number, wherein a second reformatted phone number is obtained and wherein the second reformatted phone number is a second concatenation of a second standardized country code for the second destination country and the second remaining series of digits;
save the second reformatted phone number to the communication device;
wherein if the second set of criteria is not satisfied,
decrement the second loop counter by one;
repeat the second loop until the second reformatted phone number is saved to the communication device or until five iterations of the second loop are complete; and
proceed to initiate the third logic sequence of the reformatting sequence when five iterations of the second loop are complete.

7. The at least one non-transitory computer-readable medium of claim 1, comprising instructions to:
initiate the third logic sequence of the reformatting sequence;
calculate a number of searches to be performed by subtracting a third minimum external dialing protocol (EDP) length from a third maximum EDP length;
set a third current loop index equal to the third maximum EDP length;
begin a third loop;
set a third number of digits in a third beginning series of digits in the phone number equal to the third current loop index;
capture the third beginning series of digits from the phone number, wherein a captured third substring and a third remaining series of digits are obtained;
search a database containing dialing codes and prefixes for a third series of digits that matches the captured third substring, wherein the third series of digits is a third combination of the first exit code for the first current country and a third entry code for a third destination country,
wherein if a match is found for the third series of digits,
determine if a third set of criteria is satisfied, wherein the third set of criteria is satisfied when the third remaining series of digits conforms to a third minimum rule, a third maximum rule, and a third verification rule for the third destination country,
wherein if the third set of criteria is satisfied,
designate a third standardized country code for the third destination country and the third remaining series of digits as an outcome, wherein the outcome is saved to a results array;
decrement the third current loop index by one;
wherein if the third set of criteria is not satisfied,
decrement the third current loop index by one;
wherein if the match is not found for the third series of digits,
decrement the third current loop index by one;
repeat the third loop until a third number of iterations completed equals the number of searches to be performed;
determine a results array count, wherein the results array count equals a third number of outcomes saved to the results array,
wherein if the results array count equals zero,
proceed to initiate the fourth logic sequence of the reformatting sequence;
wherein if the results array count equals one,
reformat the phone number, wherein a third reformatted phone number is obtained and wherein the third reformatted phone number is a third concatenation of the third standardized country code for the third destination country and the third remaining series of digits; and
wherein if the results array count is greater than one,
save the results array as an unresolved numbers array, wherein the unresolved numbers array is available for the manual intervention process.

8. The at least one non-transitory computer-readable medium of claim 1, comprising instructions to:
initiate the fourth logic sequence of the reformatting sequence;
determine a default country, wherein the user is located in the default country;
determine if a fourth criterion is satisfied, wherein the fourth criterion is satisfied when the phone number begins with a domestic trunk,
wherein if the fourth criterion is satisfied.
remove the domestic trunk from the phone number, wherein a fourth residual phone number is obtained;
wherein if the fourth criterion is not satisfied,
re-label the phone number as the fourth residual phone number;
determine if a fifth set of criteria is satisfied, wherein the fifth set of criteria is satisfied when the fourth residual phone number conforms to a fourth minimum rule, a fourth maximum rule, and a fourth verification rule for the default country,
wherein if the fifth set of criteria is satisfied,
reformat the phone number, wherein a fourth reformatted phone number is obtained and wherein the fourth reformatted phone number is a fourth concatenation of a fourth standardized country code for the default country and the fourth residual phone number;
wherein if the fifth set of criteria is not satisfied,
save the fourth residual phone number, wherein the fourth residual phone number is unresolved; and
proceed to initiate the manual intervention process.

9. The at least one non-transitory computer-readable medium of claim 1, comprising instructions to:
initiate the manual intervention process;
retrieve a fifth unresolved phone number selected by the user from an unresolved number display;
retrieve a fifth standardized country code selected by the user;
identify a fifth destination country represented by the fifth standardized country code;
determine if a sixth set of criteria is satisfied, wherein the sixth set of criteria is satisfied when the fifth unresolved phone number conforms to a fifth minimum rule, a fifth maximum rule, and a fifth verification rule for the fifth destination country,
wherein if the sixth set of criteria is satisfied,
reformat the fifth unresolved phone number, wherein a fifth reformatted phone number is obtained and wherein the fifth reformatted phone number is a fifth concatenation of the fifth standardized country code and the fifth unresolved phone number selected by the user;
wherein if the sixth set of criteria is not satisfied,
display a series of suggested phone numbers, wherein a suggested phone number contains at least a fifth minimum number of digits and at most a fifth maximum number of digits for the fifth destination country;
determine if a seventh criterion is satisfied, wherein the seventh criterion is satisfied when the user selects a first suggested phone number from the series of suggested phone numbers;
wherein if the seventh criterion is satisfied,
reformat the first suggested phone number, wherein a sixth reformatted phone number is obtained and wherein the sixth reformatted phone number is a sixth concatenation of the fifth standardized country code and the first suggested phone number selected by the user;
wherein if the seventh criterion is not satisfied,
enable the user to edit the fifth unresolved phone number, wherein a first edited phone number is obtained;
determine if an eighth set of criteria is satisfied, wherein the eighth set of criteria is satisfied when the first edited phone number conforms to the fifth minimum rule, the fifth maximum rule, and the fifth verification rule for the fifth destination country;
wherein if the eighth set of criteria is satisfied,
reformat the first edited phone number wherein a seventh reformatted phone number is obtained and wherein the seventh reformatted phone number is a seventh concatenation of the fifth standardized country code and the first edited phone number;
wherein if the eighth set of criteria is not satisfied,
enable the user to edit the first edited phone number until a second edited phone number satisfies the eighth set of criteria; and
reformat the second edited phone number, wherein an eighth reformatted phone number is obtained and wherein the eighth reformatted phone number is an eighth concatenation of the fifth standardized country code and the second edited phone number.

10. The at least one non-transitory computer-readable medium of claim 1, comprising instructions to:
enable the user to select a ninth reformatted phone number to be called, wherein the ninth reformatted phone number is in a sixth country and wherein the sixth country is represented by a sixth standardized country code;
initiate the domestic call logic sequence when the sixth standardized country code for the sixth country is the same as a seventh standardized country code for the first current country, wherein the user is located in the first current country; and
initiate the international call logic sequence when the sixth standardized country code for the sixth country differs from the seventh standardized country code for the first current country.

11. The at least one non-transitory computer-readable medium of claim 10, comprising instructions to:
initiate the domestic call logic sequence;
determine if a ninth criterion is satisfied, wherein the ninth criterion is satisfied when the first current country uses a domestic carrier code,
wherein if the ninth criterion is satisfied,
determine if a tenth criterion is satisfied, wherein the tenth criterion is satisfied when a first default carrier has been designated by the user;
wherein if the tenth criterion is satisfied,
proceed to determine if an eleventh criterion is satisfied;
wherein if the tenth criterion is not satisfied,
enable the user to select the first default carrier;
proceed to determine if an eleventh criterion is satisfied;
determine if the eleventh criterion is satisfied, wherein the eleventh criterion is satisfied when the first default carrier uses an intra-city logic and an inter-city logic,
wherein if the eleventh criterion is satisfied,
determine if a twelfth criterion is satisfied, wherein the twelfth criterion is satisfied when an intra-city call is to be dialed,
wherein if the twelfth criterion is satisfied,
extract a carrier intra-city code from the database containing dialing codes and prefixes;
capture the carrier intra-city code, wherein a captured carrier intra-city code is obtained;
proceed to enable the user to dial a sixth local phone number;
wherein if the twelfth criterion is not satisfied,
extract a carrier inter-city code from the database containing dialing codes and prefixes;
capture the carrier inter-city code, wherein a captured carrier inter-city code is obtained;
proceed to enable the user to dial a sixth local phone number;
wherein if the eleventh criterion is not satisfied,
capture the domestic carrier code, wherein a captured domestic carrier code is obtained;
proceed to enable the user to dial a sixth local phone number;
wherein if the ninth criterion is not satisfied,
determine if a thirteenth criterion is satisfied, wherein the thirteenth criterion is satisfied when the first current country uses a trunk prefix,
wherein if the thirteenth criterion is satisfied,
determine if a fourteenth criterion is satisfied, wherein the fourteenth criterion is satisfied when the trunk prefix differs when land lines are called and when mobile devices are called,
wherein if the fourteenth criterion is satisfied,
capture a first land-line trunk prefix or a first mobile-device trunk prefix from the database containing dialing codes and prefixes, wherein a captured first land-line trunk prefix or a captured first mobile-device trunk prefix is obtained;
proceed to enable the user to dial a sixth local phone number;
wherein if the fourteenth criterion is not satisfied,
determine if a fifteenth criterion is satisfied, wherein the fifteenth criterion is satisfied when the first current country uses a single-digit trunk await code,
wherein if the fifteenth criterion is satisfied,
capture the single-digit trunk await code from the database containing dialing codes and prefixes, wherein a captured single-digit trunk await code is obtained;
program the captured single-digit trunk await code to pause dialing for five seconds when the user dials the sixth local phone number;
proceed to enable the user to dial a sixth local phone number;
wherein if the fifteenth criterion is not satisfied,
capture the trunk prefix from the database containing dialing codes and prefixes, wherein a captured trunk prefix is obtained;
proceed to enable the user to dial a sixth local phone number;
wherein if the thirteenth criterion is not satisfied,
proceed to enable the user to dial a sixth local phone number;
enable the user to dial a sixth local phone number, wherein a dialed sixth local phone number is obtained;
initiate a domestic authentication process;
determine if a sixteenth criterion is satisfied, wherein the sixteenth criterion is satisfied when the dialed sixth local phone number matches a first verification sequence for the first current country;
wherein if the sixteenth criterion is satisfied,
display a sixth local city associated with the dialed sixth local phone number on a screen on the communication device;
determine if a seventeenth criterion is satisfied, wherein the seventeenth criterion is satisfied when the dialed sixth local phone number contains at least a sixth minimum number of digits and at most a sixth maximum number of digits for the first current country;
wherein if the seventeenth criterion is satisfied,
concatenate a captured initial code or prefix and the dialed sixth local phone number, wherein a domestic concatenation is obtained and wherein the captured initial code or prefix is selected from a captured initial code or prefix group consisting of the captured carrier intra-city code, the captured carrier inter-city code, the captured domestic carrier code, the captured first land-line trunk prefix, the captured first mobile-device trunk prefix, the captured single-digit trunk await code, and the captured trunk prefix;
save the ninth reformatted phone number to the call log on the communication device;
call the domestic concatenation;
wherein if the seventeenth criterion is not satisfied,
reset a dialer; and
wherein if the sixteenth criterion is not satisfied,
reset the dialer.

12. The at least one non-transitory computer-readable medium of claim 10, comprising instructions to:
initiate the international call logic sequence;
determine if an eighteenth criterion is satisfied, wherein the eighteenth criterion is satisfied when the first current country and a sixth destination country are members of a telecommunications alliance;
wherein if the eighteenth criterion is satisfied,
use an alliance rule logic to capture an alliance dialing code from the database containing dialing codes and prefixes, wherein a captured alliance dialing code is obtained and wherein the captured alliance dialing code is a first external dialing protocol (EDP) string;
proceed to enable the user to dial the sixth local phone number, wherein the sixth local phone number is located in the sixth destination country;
wherein if the eighteenth criterion is not satisfied,
determine if a nineteenth criterion is satisfied, wherein the nineteenth criterion is satisfied when the first current country uses an international carrier code;
wherein if the nineteenth criterion is satisfied,
capture the international carrier code from the database containing dialing codes and prefixes, wherein a captured international carrier code is obtained;
proceed to determine if a twenty-first criterion is satisfied;
wherein if the nineteenth criterion is not satisfied,
determine if a twentieth criterion is satisfied, wherein the twentieth criterion is satisfied when the first current country uses a single-digit await code and a second exit code,
wherein if the twentieth criterion is satisfied,
capture the single-digit await code and the second exit code from the database containing dialing codes and prefixes, wherein a captured single-digit await code and the second exit code are obtained;
program the captured single-digit await code to pause dialing for five seconds before the second exit code is dialed;
proceed to determine if a twenty-first criterion is satisfied;
wherein if the twentieth criterion is not satisfied,
capture the second exit code from the database containing dialing codes and prefixes, wherein a captured second exit code is obtained;
proceed to determine if a twenty-first criterion is satisfied;
determine if a twenty-first criterion is satisfied, wherein the twenty-first criterion is satisfied when the sixth destination country uses different entry codes for mobile devices and land lines,
wherein if the twenty-first criterion is satisfied,
use a mobile-device entry code logic to capture a second mobile-device entry code or use a land-line entry code logic to capture a second land-line entry code from the database containing dialing codes and prefixes, wherein a captured second mobile-device entry code or a captured second land-line entry code is obtained;
concatenate a current country EDP, a sixth destination country entry code, and the captured second mobile-device entry code or the captured second land-line entry code, wherein a second EDP string is obtained and wherein the current country EDP is selected from a current country EDP group consisting of the captured international carrier code, the captured single-digit await code and the second exit code, and the captured second exit code;
proceed to enable the user to dial the sixth local phone number;
wherein if the twenty-first criterion is not satisfied,
concatenate the current country EDP and the sixth destination country entry code, wherein a third EDP string is obtained and wherein the current country EDP is selected from the current country EDP group;
proceed to enable the user to dial the sixth local phone number;
enable the user to dial the sixth local phone number, wherein a dialed sixth local phone number is obtained;
initiate an international authentication process;
determine if a twenty-second criterion is satisfied, wherein the twenty-second criterion is satisfied when the dialed sixth local phone number matches a second verification sequence for the sixth destination country;
wherein if the twenty-second criterion is satisfied,
display a second destination city associated with the dialed sixth local phone number on the screen on the communication device;
determine if a twenty-third criterion is satisfied, wherein the twenty-third criterion is satisfied when the dialed sixth local phone number contains at least a seventh minimum number of digits and at most a seventh maximum number of digits for the sixth destination country;
wherein if the twenty-third criterion is satisfied,
concatenate an EDP string and the dialed sixth local phone number, wherein an international concatenation is obtained and wherein the EDP string is selected from an EDP string group consisting of the first EDP string, the second EDP string, and the third EDP string;
save the ninth reformatted phone number to the call log;
call the international concatenation;
wherein if the twenty-third criterion is not satisfied,
reset the dialer;
enable the user to redial the sixth local phone number;
wherein if the twenty-second criterion is not satisfied,
reset the dialer; and
enable the user to redial the sixth local phone number.

13. The at least one non-transitory computer-readable medium of claim 12, comprising instructions to:
initiate the alliance rule logic;
find a common telecommunications alliance by comparing a first record for the first current country and a second record for the sixth destination country in the database containing dialing codes and prefixes;
capture an alliance dialing code from the second record for the sixth destination country, wherein a captured alliance dialing code is obtained;
enable the user to dial the sixth local phone number, wherein the dialed sixth local phone number is obtained;
determine if a twenty-fourth criterion is satisfied, wherein the twenty-fourth criterion is satisfied when the dialed sixth local phone number matches the second verification sequence for the sixth destination country;
wherein if the twenty-fourth criterion is satisfied,
display the second destination city associated with the dialed sixth local phone number on the screen on the communication device;
determine if a twenty-fifth criterion is satisfied, wherein the twenty-fifth criterion is satisfied when the dialed sixth local phone number contains at least the seventh minimum number of digits and at most the seventh maximum number of digits for the sixth destination country;
wherein if the twenty-fifth criterion is satisfied,
concatenate the captured alliance dialing code and the dialed sixth local phone number, wherein an alliance concatenation is obtained;
save the ninth reformatted phone number to the call log;
call the alliance concatenation;
wherein if the twenty-fifth criterion is not satisfied,
reset the dialer;
enable the user to redial the sixth local phone number;
wherein if the twenty-fourth criterion is not satisfied,
reset the dialer; and
enable the user to redial the sixth local phone number.

14. The at least one non-transitory computer-readable medium of claim 1, comprising instructions to:
initiate the verification process;
enable the user to dial the local phone number until a sixth digit has been dialed, wherein a six-digit series is created;
determine if a twenty-sixth criterion is satisfied, wherein the twenty-sixth criterion is satisfied when the user is making a domestic phone call;
wherein if the twenty-sixth criterion is satisfied,
capture a current country entry code from the database containing dialing codes and prefixes, wherein a captured current country entry code is obtained;
determine if a twenty-seventh criterion is satisfied, wherein the twenty-seventh criterion is satisfied when the domestic phone call is toll free;
wherein if the twenty-seventh criterion is satisfied,
restrict a search of a verification database to toll-free validation entries;
proceed to combine a captured entry code with the six-digit series;
wherein if the twenty-seventh criterion is not satisfied, proceed to combine a captured entry code with the six-digit series;
wherein if the twenty-sixth criterion is not satisfied,
capture a destination country entry code from the database containing dialing codes and prefixes, wherein a captured destination country entry code is obtained;
proceed to combine a captured entry code with the six-digit series;
combine a captured entry code with the six-digit series, wherein a verification string is created and wherein the captured entry code is the captured current country entry code or the captured destination country entry code;
set a validation loop counter equal to one;
begin a validation loop,
search the verification database for a validation entry that matches the verification string;
determine if a twenty-eighth criterion is satisfied, wherein the twenty-eighth criterion is satisfied when the validation entry matching the verification string is found;
wherein if the twenty-eighth criterion is satisfied,
update a city label field on a global dialer screen on the communication device by displaying a validation entry description;
proceed to enable the user to continue dialing the local phone number;
wherein if the twenty-eighth criterion is not satisfied,
determine if a twenty-ninth criterion is satisfied, wherein the twenty-ninth criterion is satisfied when the validation loop counter equals six;
wherein if the twenty-ninth criterion is satisfied,
display an alert indicating that the local phone number does not satisfy the verification process;
determine if a thirtieth criterion is satisfied, wherein the thirtieth criterion is satisfied when the user attempts to continue dialing;
wherein if the thirtieth criterion is satisfied,
enable the user to continue dialing the local phone number;
wherein if the thirtieth criterion is not satisfied,
reset the dialer;
wherein if the twenty-ninth criterion is not satisfied,
decrease a fourth number of digits in the verification string by a value of the validation loop counter;
increment the validation loop counter by one;
repeat the validation loop until the validation entry matching the verification string is found or until six iterations of the validation loop are complete.

15. A method for using a global dialing format, comprising:
retrieving a phone number stored on a communication device;
initiating a reformatting sequence to reformat the phone number;
executing a manual intervention sequence when the reformatting sequence is unable to reformat the phone number;
saving a reformatted phone number to a global contacts list in the global dialing format, wherein the reformatted phone number is obtained from the reformatting sequence or from the manual intervention sequence and wherein the global contacts list is located on the communication device;
retrieving a local phone number from the reformatted phone number when a user selects the reformatted phone number;
comparing a current country of the user to a destination country of the local phone number;
initiating a domestic call logic sequence or an international call logic sequence;
authenticating the local phone number by determining that the local phone number is a valid phone number in the destination country, wherein an authenticated local phone number is obtained;
concatenating a dialing protocol and the authenticated local phone number to obtain a concatenated phone number;
saving the phone number to a call log in the global dialing format; and
calling the concatenated phone number.

16. The method of claim 15, wherein initiating a reformatting sequence to reformat the phone number comprises:
implementing a first logic sequence when the phone number starts with a “+” symbol;
implementing a second logic sequence when the phone number starts with an exit code for the current country of the user and any exit code;
implementing a third logic sequence when the phone number starts with any combination of an exit code and an entry code; or
implementing a fourth logic sequence when the phone number conforms to a minimum rule and a maximum rule for the current country of the user.

17. The method of claim 15, wherein saving a reformatted phone number to a global contacts list in the global dialing format comprises:
concatenating a three-letter International Organization for Standardization (ISO) country code for the destination country and the local phone number in the destination country to obtain a reformatted phone number and
saving the reformatted phone number to the global contacts list, wherein the reformatted phone number is in the global dialing format.

18. The method of claim 15, wherein comparing a current country of the user to a destination country of the local phone number comprises:
determining a first three-letter ISO country code for the current country;
determining a second three-letter ISO country code for the destination country; and
comparing the first three-letter ISO country code and the second three-letter ISO country code.

19. The method of claim 15, wherein initiating a domestic call logic sequence or an international call logic sequence comprises:
executing the domestic call logic sequence when the first three-letter ISO country code is the same as the second three-letter ISO country code or
executing the international call logic sequence when the first three-letter ISO country code differs from the second three-letter ISO country code.

20. The method of claim 15, wherein authenticating the local phone number by determining that the local phone number is a valid phone number in the destination country comprises:
satisfying a verification process by establishing that a series of digits at the beginning of the local phone number matches a verification sequence for the destination country, wherein the series of digits contains one to six digits and
satisfying a digit count process by establishing that the local phone number conforms to a minimum rule and a maximum rule for the destination country.
